(19) United States
(12) Patent Application Publication
(10) Pub. No.: US 2019/0251716 A1
(43) Pub. Date: Aug. 15, 2019

(54) SYSTEM AND METHOD FOR VISUAL SCENE CONSTRUCTION BASED ON USER COMMUNICATION

(71) Applicant: DMAI, Inc., Los Angeles, CA (US)

(72) Inventor: Jeremy Nelson, Los Angeles, CA (US)

(21) Appl. No.: 16/277,599

(22) Filed: Feb. 15, 2019

Related U.S. Application Data
(60) Provisional application No. 62/630,892, filed on Feb. 15, 2018.

(51) Int. Cl. G06T 11/20; G06F 17/27; G10L 15/18; G06F 3/16

(52) U.S. Cl. CPC G06T 11/20; G06F 17/2785; G06T 2210/61; G06F 3/167; G10L 15/1815

(57) ABSTRACT

The present teaching relates to method, system, medium, and implementations for visualizing a scene. An input is first received with a description of a visual scene. Linguistic processing is performed on the input to obtain semantics of the input, which is then used to generate a scene log for rendering the visual scene. The scene log specifies at least one of a background of the visual scene, one or more entities/objects that are to appear in the visual scene, and at least one parameter associated with the one or more entities/objects to be used to visualize the one or more entities/objects in the background in a manner consistent with the semantics of the input. The visual scene is then rendered based on the scene log by visualizing the background and the one or more entities/objects in accordance with the at least one parameter.

### CROSS-REFERENCE TO RELATED APPLICATIONS

This application claims priority to U.S. Provisional Patent Application 62/630,892, filed Feb. 15, 2018, the contents of which are incorporated herein by reference in its entirety.

The present application is related to International Application ______, filed Feb. 15, 2019 (Attorney Docket No.: 047437-0461788), International Application ______, filed Feb. 15, 2019 (Attorney Docket No.: 047437-0461789), U.S. patent application Ser. No. ______, filed Feb. 15, 2019 (Attorney Docket No.: 047437-0503026), International Application ______, filed Feb. 15, 2019 (Attorney Docket No.: 047437-0461790), U.S. patent application Ser. No. ______, filed Feb. 15, 2019 (Attorney Docket No.: 047437-0503027), International Application ______, filed Feb. 15, 2019 (Attorney Docket No.: 047437-0461808), U.S. patent application Ser. No. ______, filed Feb. 15, 2019 (Attorney Docket No.: 047437-0503028), International Application ______, filed Feb. 15, 2019 (Attorney Docket No.: 047437-0461809), U.S. patent application Ser. No. ______, filed Feb. 15, 2019 (Attorney Docket No.: 047437-0503029), International Application ______, filed Feb. 15, 2019 (Attorney Docket No.: 047437-0461810), U.S. patent application Ser. No. ______, filed Feb. 15, 2019 (Attorney Docket No.: 047437-0503030), International Application ______, filed Feb. 15, 2019 (Attorney Docket No.: 047437-0461819), U.S. patent application Ser. No. ______, filed Feb. 15, 2019 (Attorney Docket No.: 047437-0503031), International Application ______, filed Feb. 15, 2019 (Attorney Docket No.: 047437-0461811), U.S. patent application Ser. No. ______, filed Feb. 15, 2019 (Attorney Docket No.: 047437-0502960), International Application ______, filed Feb. 15, 2019 (Attorney Docket No.: 047437-0502961), U.S. patent application Ser. No. ______, filed Feb. 15, 2019 (Attorney Docket No.: 047437-0503035), International Application ______, filed Feb. 15, 2019 (Attorney Docket No.: 047437-0461814), U.S. patent application Ser. No. ______, filed Feb. 15, 2019 (Attorney Docket No.: 047437-0502963), International Application ______, filed Feb. 15, 2019 (Attorney Docket No.: 047437-0502966), U.S. patent application Ser. No. ______, filed Feb. 15, 2019 (Attorney Docket No.: 047437-0502964), International Application ______, filed Feb. 15, 2019 (Attorney Docket No.: 047437-0502965), U.S. patent application Ser. No. ______, filed Feb. 15, 2019 (Attorney Docket No.: 047437-0503032), International Application ______, filed Feb. 15, 2019 (Attorney Docket No.: 047437-0461820), U.S. patent application Ser. No. ______, filed Feb. 15, 2019 (Attorney Docket No.: 047437-0503017), which are hereby incorporated by reference in their entireties.

### BACKGROUND

### 1. Technical Field

The present teaching generally relates to computer. More specifically, the present teaching relates to computerized intelligent agent.

### 2. Technical Background

With advancement of artificial intelligence technologies and the explosion Internet based communications because of the ubiquitous Internet's connectivity, computer aided dialogue systems have become increasingly popular. For example, more and more call centers deploy automated dialogue robot to handle customer calls. Hotels started to install various kiosks that can answer questions from tourists or guests. Online bookings (whether travel accommodations or theater tickets, etc.) are also more frequently done by chatbots. In recent years, automated human machine communications in other areas are also becoming more and more popular.

Such traditional computer aided dialogue systems are usually pre-programed with certain questions and answers based on commonly known patterns of conversations in different domains. Unfortunately, human conversant can be unpredictable and sometimes does not follow a pre-planned dialogue pattern. In addition, in certain situations, a human conversant may digress during the process and continue the fixed conversation patterns likely will cause irritation or loss of interests. When this happens, such machine traditional dialogue systems often will not be able to continue to engage a human conversant so that the human machine dialogue either has to be aborted to hand the tasks to a human operator or the human conversant simply leaves the dialogue, which is undesirable.

In addition, traditional machine based dialogue systems are often not designed to address the emotional factor of a human, let alone taking into consideration as to how to address such emotional factor when conversing with a human. For example, a traditional machine dialogue system usually does not initiate the conversation unless a human activates the system or asks some questions. Even if a traditional dialogue system does initiate a conversation, it has a fixed way to start a conversation and does not change from human to human or adjusted based on observations. As such, although they are programmed to faithfully follow the pre-designed dialogue pattern, they are usually not able to act on the dynamics of the conversation and adapt in order to keep the conversation going in a way that can engage the human. In many situations, when a human involved in a dialogue is clearly annoyed or frustrated, a traditional machine dialogue systems is completely unaware and continue the conversation in the same manner that has annoyed the human. This not only makes the conversation end unpleasantly (the machine is still unaware of that) but also turns the person away from conversing with any machine based dialogue system in the future.

In some application, conducting a human machine dialogue session based on what is observed from the human is crucially important in order to determine how to proceed effectively. One example is an education related dialogue. When a chatbot is used for teaching a child to read, whether the child is perceptive to the way he/she is being taught has to be monitored and addressed continuously in order to be effective. Another limitation of the traditional dialogue systems is their context unawareness. For example, a traditional dialogue system is not equipped with the ability to observe the context of a conversation and improvise as to dialogue strategy in order to engage a user and improve the user experience.

Thus, there is a need for methods and systems that address such limitations.

### SUMMARY

The teachings disclosed herein relate to methods, systems, and programming for a computerized intelligent agent.

In one example, a method, implemented on a machine having at least one processor, storage, and a communication platform capable of connecting to a network for visualizing a scene. An input is first received with a description of a visual scene. Linguistic processing is performed on the input to obtain semantics of the input, which is then used to generate a scene log for rendering the visual scene. The scene log specifies at least one of a background of the visual scene, one or more entities/objects that are to appear in the visual scene, and at least one parameter associated with the one or more entities/objects to be used to visualize the one or more entities/objects in the background in a manner consistent with the semantics of the input. The visual scene is then rendered based on the scene log by visualizing the background and the one or more entities/objects in accordance with the at least one parameter.

In a different example, a system for visualizing a scene. The system includes a textual input based scene understanding unit and a semantics-based visual scene rendering unit. The textual input based scene understanding unit is configured for receiving an input with a description of a visual scene, performing linguistic processing of the input to obtain semantics of the input, and generating a scene log to be used for rendering the visual scene based on the semantics of the input. The generated scene log includes at least one of a background of the visual scene, one or more entities/objects that are to appear in the visual scene, and at least one parameter associated with the one or more entities/objects to be used to visualize the one or more entities/objects in the background in a manner consistent with the semantics of the input. The semantics based visual scene rendering unit is configured for rendering the visual scene based on the scene log by visualizing the background and the one or more entities/objects in accordance with the at least one parameter.

Other concepts relate to software for implementing the present teaching. A software product, in accord with this concept, includes at least one machine-readable non-transitory medium and information carried by the medium. The information carried by the medium may be executable program code data, parameters in association with the executable program code, and/or information related to a user, a request, content, or other additional information.

In one example, a machine-readable, non-transitory and tangible medium having data recorded thereon for visualizing a scene, wherein the medium, when read by the machine, causes the machine to perform a series of steps. An input is first received with a description of a visual scene. Linguistic processing is performed on the input to obtain semantics of the input, which is then used to generate a scene log for rendering the visual scene. The scene log specifies at least one of a background of the visual scene, one or more entities/objects that are to appear in the visual scene, and at least one parameter associated with the one or more entities/objects to be used to visualize the one or more entities/objects in the background in a manner consistent with the semantics of the input. The visual scene is then rendered based on the scene log by visualizing the background and the one or more entities/objects in accordance with the at least one parameter.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts a networked environment for facilitating a dialogue between a user operating a user device and an agent device in conjunction with a user interaction engine, in accordance with an embodiment of the present teaching;

FIGS. 2A-2B depict connections among a user device, an agent device, and a user interaction engine during a dialogue, in accordance with an embodiment of the present teaching;

FIG. 3A illustrates an exemplary structure of an agent device with exemplary types of agent body, in accordance with an embodiment of the present teaching;

FIG. 3B illustrates an exemplary agent device, in accordance with an embodiment of the present teaching;

FIG. 4A depicts an exemplary high level system diagram for an overall system for the automated companion, according to various embodiments of the present teaching;

FIG. 4B illustrates a part of a dialogue tree of an on-going dialogue with paths taken based on interactions between the automated companion and a user, according to an embodiment of the present teaching;

FIG. 4C illustrates exemplary a human-agent device interaction and exemplary processing performed by the automated companion, according to an embodiment of the present teaching;

FIG. 5 illustrates exemplary multiple layer processing and communications among different processing layers of an automated dialogue companion, according to an embodiment of the present teaching;

FIG. 6 depicts an exemplary high level system framework for an artificial intelligence based educational companion, according to an embodiment of the present teaching;

FIG. 7 illustrates a framework of rendering a visual scene based on utterance from a user, according to embodiments of the present teaching;

FIG. 8 shows an example of a visual scene rendered based on utterances of a user, according to an embodiment of the present teaching;

FIG. 9A illustrates an exemplary construct of a semantic-based session scene log, according to an embodiment of the present teaching;

FIG. 9B illustrates an exemplary organization and content of a scene log, according to an embodiment of the present teaching;

FIG. 10 depicts an exemplary high level system diagram of a voice input based scene understanding unit, according to an embodiment of the present teaching;

FIG. 11 is a flowchart of an exemplary process of a voice input based scene understanding unit, according to an embodiment of the present teaching;

FIG. 12 depicts an exemplary high level system diagram of a voice input based visual scene rendering unit, according to an embodiment of the present teaching;

FIG. 13 is a flowchart of an exemplary process of a voice input based visual scene rendering unit, according to an embodiment of the present teaching;

FIG. 14 is an illustrative diagram of an exemplary mobile device architecture that may be used to realize a specialized system implementing the present teaching in accordance with various embodiments; and

FIG. 15 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present teaching aims to address the deficiencies of the traditional human machine dialogue systems and to provide methods and systems that enables a more effective and realistic human to machine dialogue. The present teaching incorporates artificial intelligence in an automated companion with an agent device in conjunction with the backbone support from a user interaction engine so that the automated companion can conduct a dialogue based on continuously monitored multimodal data indicative of the surrounding of the dialogue, adaptively estimating the mindset/emotion/intent of the participants of the dialogue, and adaptively adjust the conversation strategy based on the dynamically changing information/estimates/contextual information.

The automated companion according to the present teaching is capable of personalizing a dialogue by adapting in multiple fronts, including, but is not limited to, the subject matter of the conversation, the hardware/components used to carry out the conversation, and the expression/behavior/gesture used to deliver responses to a human conversant. The adaptive control strategy is to make the conversation more realistic and productive by flexibly changing the conversation strategy based on observations on how receptive the human conversant is to the dialogue. The dialogue system according to the present teaching can be configured to achieve a goal driven strategy, including dynamically configuring hardware/software components that are considered most appropriate to achieve an intended goal. Such optimizations are carried out based on learning, including learning from prior conversations as well as from an on-going conversation by continuously assessing a human conversant's behavior/reactions during the conversation with respect to some intended goals. Paths exploited to achieve a goal driven strategy may be determined to remain the human conversant engaged in the conversation even though in some instances, paths at some moments of time may appear to be deviating from the intended goal.

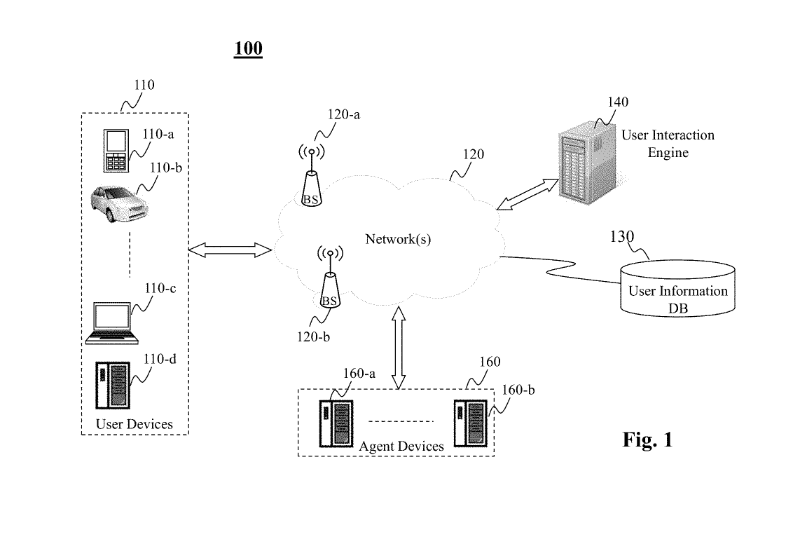

More specifically, the present teaching discloses a user interaction engine providing backbone support to an agent device to facilitate more realistic and more engaging dialogues with a human conversant. FIG. 1 depicts a networked environment 100 for facilitating a dialogue between a user operating a user device and an agent device in conjunction with a user interaction engine, in accordance with an embodiment of the present teaching. In FIG. 1, the exemplary networked environment 100 includes one or more user devices 110, such as user devices 110-a, 110-b, 110-c, and 110-d, one or more agent devices 160, such as agent devices 160-a, . . . 160-b, a user interaction engine 140, and a user information database 130, each of which may communicate with one another via network 120. In some embodiments, network 120 may correspond to a single network or a combination of different networks. For example, network 120 may be a local area network (“LAN”), a wide area network (“WAN”), a public network, a proprietary network, a proprietary network, a Public Telephone Switched Network (“PSTN”), the Internet, an intranet, a Bluetooth network, a wireless network, a virtual network, and/or any combination thereof. In one embodiment, network 120 may also include various network access points. For example, environment 100 may include wired or wireless access points such as, without limitation, base stations or Internet exchange points 120-a, . . . , 120-b. Base stations 120-a and 120-b may facilitate, for example, communications to/from user devices 110 and/or agent devices 160 with one or more other components in the networked framework 100 across different types of network.

A user device, e.g., 110-a, may be of different types to facilitate a user operating the user device to connect to network 120 and transmit/receive signals. Such a user device 110 may correspond to any suitable type of electronic/computing device including, but not limited to, a desktop computer (110-d), a mobile device (110-a), a device incorporated in a transportation vehicle (110-b), . . . , a mobile computer (110-c), or a stationary device/computer (110-d). A mobile device may include, but is not limited to, a mobile phone, a smart phone, a personal display device, a personal digital assistant (“PDAs”), a gaming console/device, a wearable device such as a watch, a Fitbit, a pin/broach, a headphone, etc. A transportation vehicle embedded with a device may include a car, a truck, a motorcycle, a boat, a ship, a train, or an airplane. A mobile computer may include a laptop, an Ultrabook device, a handheld device, etc. A stationary device/computer may include a television, a set top box, a smart household device (e.g., a refrigerator, a microwave, a washer or a dryer, an electronic assistant, etc.), and/or a smart accessory (e.g., a light bulb, a light switch, an electrical picture frame, etc.).

An agent device, e.g., any of 160-a, . . . , 160-b, may correspond one of different types of devices that may communicate with a user device and/or the user interaction engine 140. Each agent device, as described in greater detail below, may be viewed as an automated companion device that interfaces with a user with, e.g., the backbone support from the user interaction engine 140. An agent device as described herein may correspond to a robot which can be a game device, a toy device, a designated agent device such as a traveling agent or weather agent, etc. The agent device as disclosed herein is capable of facilitating and/or assisting in interactions with a user operating user device. In doing so, an agent device may be configured as a robot capable of controlling some of its parts, via the backend support from the application server 130, for, e.g., making certain physical movement (such as head), exhibiting certain facial expression (such as curved eyes for a smile), or saying things in a certain voice or tone (such as exciting tones) to display certain emotions.

When a user device (e.g., user device 110-a) is connected to an agent device, e.g., 160-a (e.g., via either a contact or contactless connection), a client running on a user device, e.g., 110-a, may communicate with the automated companion (either the agent device or the user interaction engine or both) to enable an interactive dialogue between the user operating the user device and the agent device. The client may act independently in some tasks or may be controlled remotely by the agent device or the user interaction engine 140. For example, to respond to a questions from a user, the agent device or the user interaction engine 140 may control the client running on the user device to render the speech of the response to the user. During a conversation, an agent device may include one or more input mechanisms (e.g., cameras, microphones, touch screens, buttons, etc.) that allow the agent device to capture inputs related to the user or the local environment associated with the conversation. Such inputs may assist the automated companion to develop an understanding of the atmosphere surrounding the conversation (e.g., movements of the user, sound of the environment) and the mindset of the human conversant (e.g., user picks up a ball which may indicates that the user is bored) in order to enable the automated companion to react accordingly and conduct the conversation in a manner that will keep the user interested and engaging.

In the illustrated embodiments, the user interaction engine 140 may be a backend server, which may be centralized or distributed. It is connected to the agent devices and/or user devices. It may be configured to provide backbone support to agent devices 160 and guide the agent devices to conduct conversations in a personalized and customized manner. In some embodiments, the user interaction engine 140 may receive information from connected devices (either agent devices or user devices), analyze such information, and control the flow of the conversations by sending instructions to agent devices and/or user devices. In some embodiments, the user interaction engine 140 may also communicate directly with user devices, e.g., providing dynamic data, e.g., control signals for a client running on a user device to render certain responses.

Generally speaking, the user interaction engine 140 may control the state and the flow of conversations between users and agent devices. The flow of each of the conversations may be controlled based on different types of information associated with the conversation, e.g., information about the user engaged in the conversation (e.g., from the user information database 130), the conversation history, surround information of the conversations, and/or the real time user feedbacks. In some embodiments, the user interaction engine 140 may be configured to obtain various sensory inputs such as, and without limitation, audio inputs, image inputs, haptic inputs, and/or contextual inputs, process these inputs, formulate an understanding of the human conversant, accordingly generate a response based on such understanding, and control the agent device and/or the user device to carry out the conversation based on the response. As an illustrative example, the user interaction engine 140 may receive audio data representing an utterance from a user operating user device, and generate a response (e.g., text) which may then be delivered to the user in the form of a computer generated utterance as a response to the user. As yet another example, the user interaction engine 140 may also, in response to the utterance, generate one or more instructions that control an agent device to perform a particular action or set of actions.

As illustrated, during a human machine dialogue, a user, as the human conversant in the dialogue, may communicate across the network 120 with an agent device or the user interaction engine 140. Such communication may involve data in multiple modalities such as audio, video, text, etc. Via a user device, a user can send data (e.g., a request, audio signal representing an utterance of the user, or a video of the scene surrounding the user) and/or receive data (e.g., text or audio response from an agent device). In some embodiments, user data in multiple modalities, upon being received by an agent device or the user interaction engine 140, may be analyzed to understand the human user's speech or gesture so that the user's emotion or intent may be estimated and used to determine a response to the user.

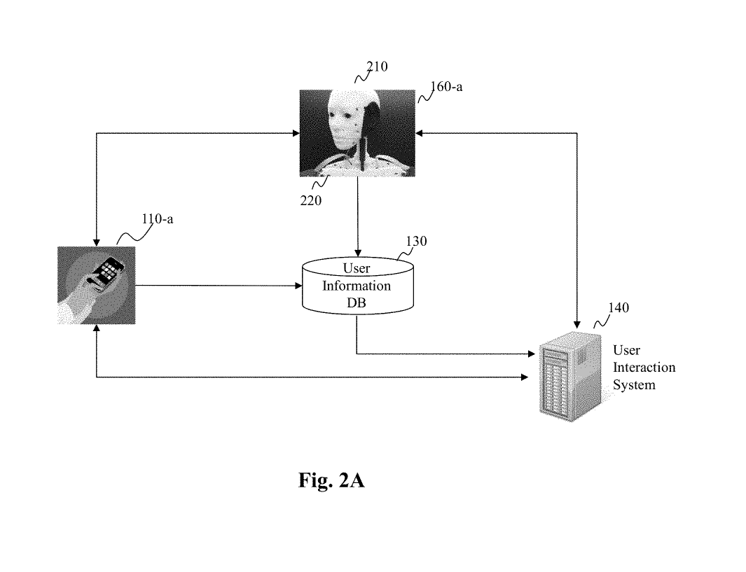

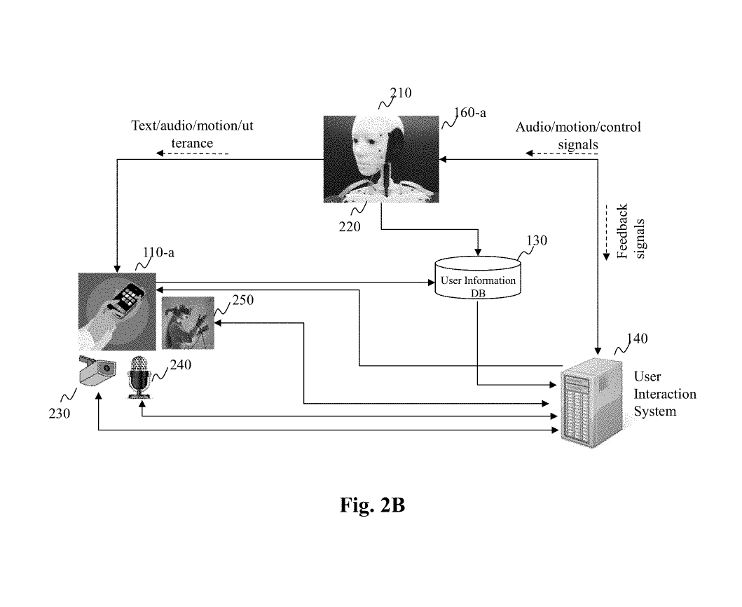

FIG. 2A depicts specific connections among a user device 110-a, an agent device 160-a, and the user interaction engine 140 during a dialogue, in accordance with an embodiment of the present teaching. As seen, connections between any two of the parties may all be bi-directional, as discussed herein. The agent device 160-a may interface with the user via the user device 110-a to conduct a dialogue in a bi-directional communications. On one hand, the agent device 160-a may be controlled by the user interaction engine 140 to utter a response to the user operating the user device 110-a. On the other hand, inputs from the user site, including, e.g., both the user's utterance or action as well as information about the surrounding of the user, are provided to the agent device via the connections. The agent device 160-a may be configured to process such input and dynamically adjust its response to the user. For example, the agent device may be instructed by the user interaction engine 140 to render a tree on the user device. Knowing that the surrounding environment of the user (based on visual information from the user device) shows green trees and lawns, the agent device may customize the tree to be rendered as a lush green tree. If the scene from the user site shows that it is a winter weather, the agent device may control to render the tree on the user device with parameters for a tree that has no leaves. As another example, if the agent device is instructed to render a duck on the user device, the agent device may retrieve information from the user information database 130 on color preference and generate parameters for customizing the duck in a user's preferred color before sending the instruction for the rendering to the user device.

In some embodiments, such inputs from the user's site and processing results thereof may also be transmitted to the user interaction engine 140 for facilitating the user interaction engine 140 to better understand the specific situation associated with the dialogue so that the user interaction engine 140 may determine the state of the dialogue, emotion/mindset of the user, and to generate a response that is based on the specific situation of the dialogue and the intended purpose of the dialogue (e.g., for teaching a child the English vocabulary). For example, if information received from the user device indicates that the user appears to be bored and become impatient, the user interaction engine 140 may determine to change the state of dialogue to a topic that is of interest of the user (e.g., based on the information from the user information database 130) in order to continue to engage the user in the conversation.

In some embodiments, a client running on the user device may be configured to be able to process raw inputs of different modalities acquired from the user site and send the processed information (e.g., relevant features of the raw inputs) to the agent device or the user interaction engine for further processing. This will reduce the amount of data transmitted over the network and enhance the communication efficiency. Similarly, in some embodiments, the agent device may also be configured to be able to process information from the user device and extract useful information for, e.g., customization purposes. Although the user interaction engine 140 may control the state and flow control of the dialogue, making the user interaction engine 140 light weight improves the user interaction engine 140 scale better.

FIG. 2B depicts the same setting as what is presented in FIG. 2A with additional details on the user device 110-a. As shown, during a dialogue between the user and the agent 210, the user device 110-a may continually collect multi-modal sensor data related to the user and his/her surroundings, which may be analyzed to detect any information related to the dialogue and used to intelligently control the dialogue in an adaptive manner. This may further enhance the user experience or engagement. FIG. 2B illustrates exemplary sensors such as video sensor 230, audio sensor 240, . . . , or haptic sensor 250. The user device may also send textual data as part of the multi-model sensor data. Together, these sensors provide contextual information surrounding the dialogue and can be used for the user interaction engine 140 to understand the situation in order to manage the dialogue. In some embodiment, the multi-modal sensor data may first be processed on the user device and important features in different modalities may be extracted and sent to the user interaction engine 140 so that dialogue may be controlled with an understanding of the context. In some embodiments, the raw multi-modal sensor data may be sent directly to the user interaction engine 140 for processing.

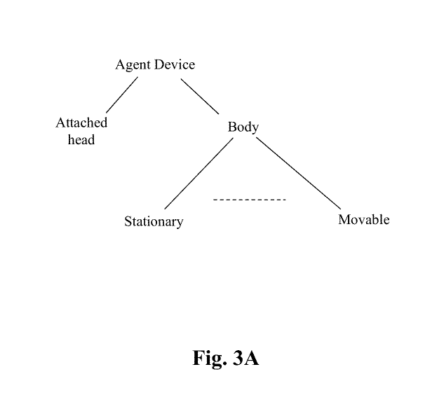

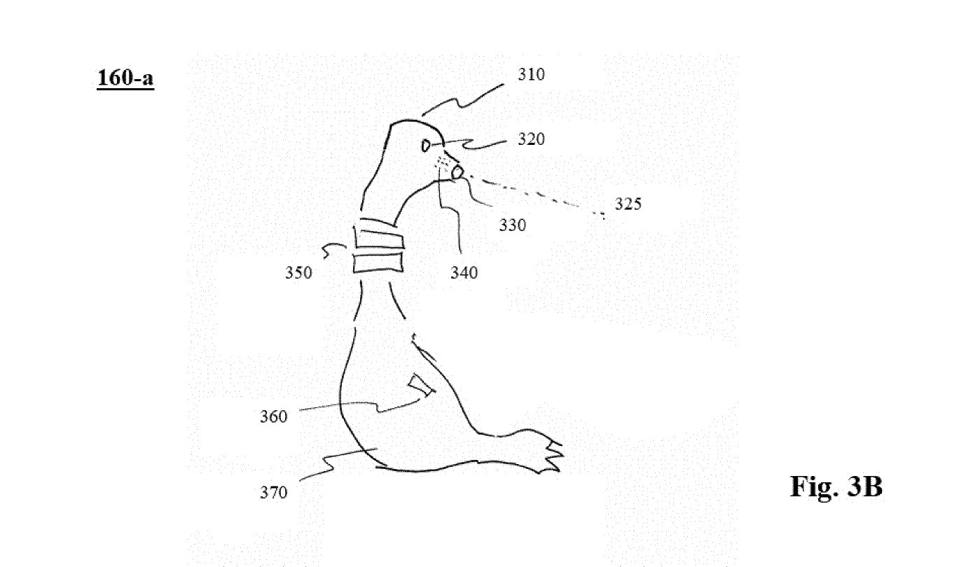

As seen in FIGS. 2A-2B, the agent device may correspond to a robot that has different parts, including its head 210 and its body 220. Although the agent device as illustrated in FIGS. 2A-2B appears to be a person robot, it may also be constructed in other forms as well, such as a duck, a bear, a rabbit, etc. FIG. 3A illustrates an exemplary structure of an agent device with exemplary types of agent body, in accordance with an embodiment of the present teaching. As presented, an agent device may include a head and a body with the head attached to the body. In some embodiments, the head of an agent device may have additional parts such as face, nose and mouth, some of which may be controlled to, e.g., make movement or expression. In some embodiments, the face on an agent device may correspond to a display screen on which a face can be rendered and the face may be of a person or of an animal. Such displayed face may also be controlled to express emotion.

The body part of an agent device may also correspond to different forms such as a duck, a bear, a rabbit, etc. The body of the agent device may be stationary, movable, or semi-movable. An agent device with stationary body may correspond to a device that can sit on a surface such as a table to conduct face to face conversation with a human user sitting next to the table. An agent device with movable body may correspond to a device that can move around on a surface such as table surface or floor. Such a movable body may include parts that can be kinematically controlled to make physical moves. For example, an agent body may include feet which can be controlled to move in space when needed. In some embodiments, the body of an agent device may be semi-movable, i.e., some parts are movable and some are not. For example, a tail on the body of an agent device with a duck appearance may be movable but the duck cannot move in space. A bear body agent device may also have arms that may be movable but the bear can only sit on a surface.

FIG. 3B illustrates an exemplary agent device or automated companion 160-a, in accordance with an embodiment of the present teaching. The automated companion 160-a is a device that interacts with people using speech and/or facial expression or physical gestures. For example, the automated companion 160-a corresponds to an animatronic peripheral device with different parts, including head portion 310, eye portion (cameras) 320, a mouth portion with laser 325 and a microphone 330, a speaker 340, neck portion with servos 350, one or more magnet or other components that can be used for contactless detection of presence 360, and a body portion corresponding to, e.g., a charge base 370. In operation, the automated companion 160-a may be connected to a user device which may include a mobile multi-function device (110-a) via network connections. Once connected, the automated companion 160-a and the user device interact with each other via, e.g., speech, motion, gestures, and/or via pointing with a laser pointer.

Other exemplary functionalities of the automated companion 160-a may include reactive expressions in response to a user's response via, e.g., an interactive video cartoon character (e.g., avatar) displayed on, e.g., a screen as part of a face on the automated companion. The automated companion may use a camera (320) to observe the user's presence, facial expressions, direction of gaze, surroundings, etc. An animatronic embodiment may “look” by pointing its head (310) containing a camera (320), “listen” using its microphone (340), “point” by directing its head (310) that can move via servos (350). In some embodiments, the head of the agent device may also be controlled remotely by a, e.g., the user interaction engine 140 or by a client in a user device (110-a), via a laser (325). The exemplary automated companion 160-a as shown in FIG. 3B may also be controlled to “speak” via a speaker (330).

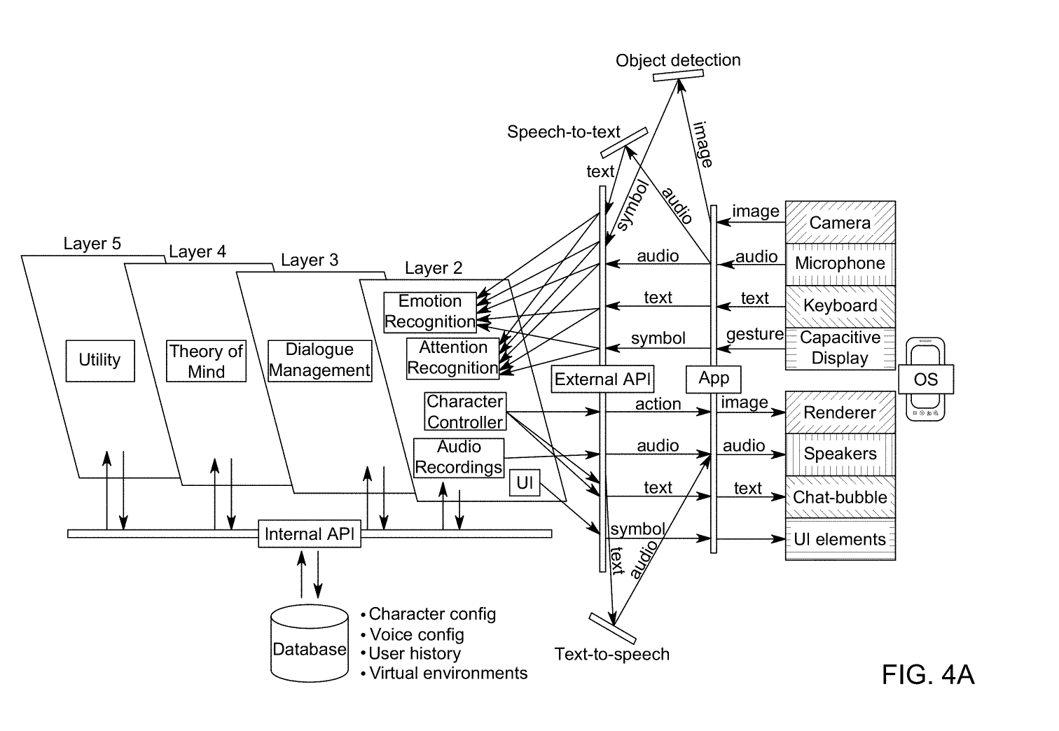

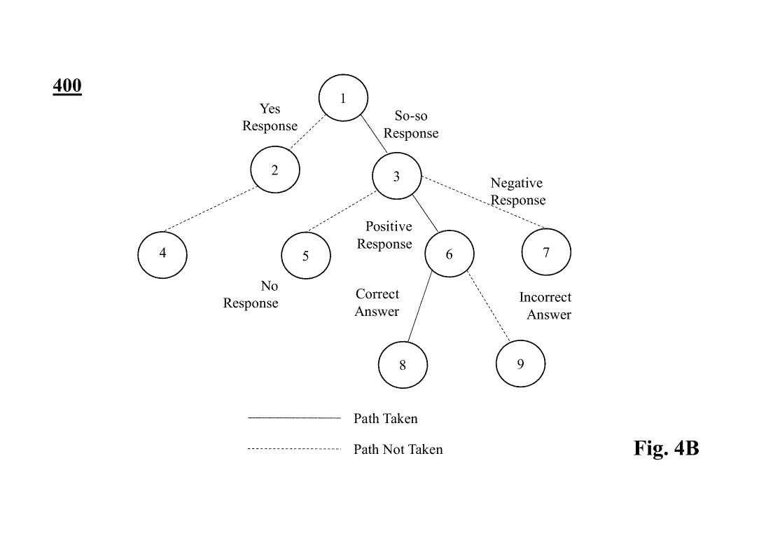

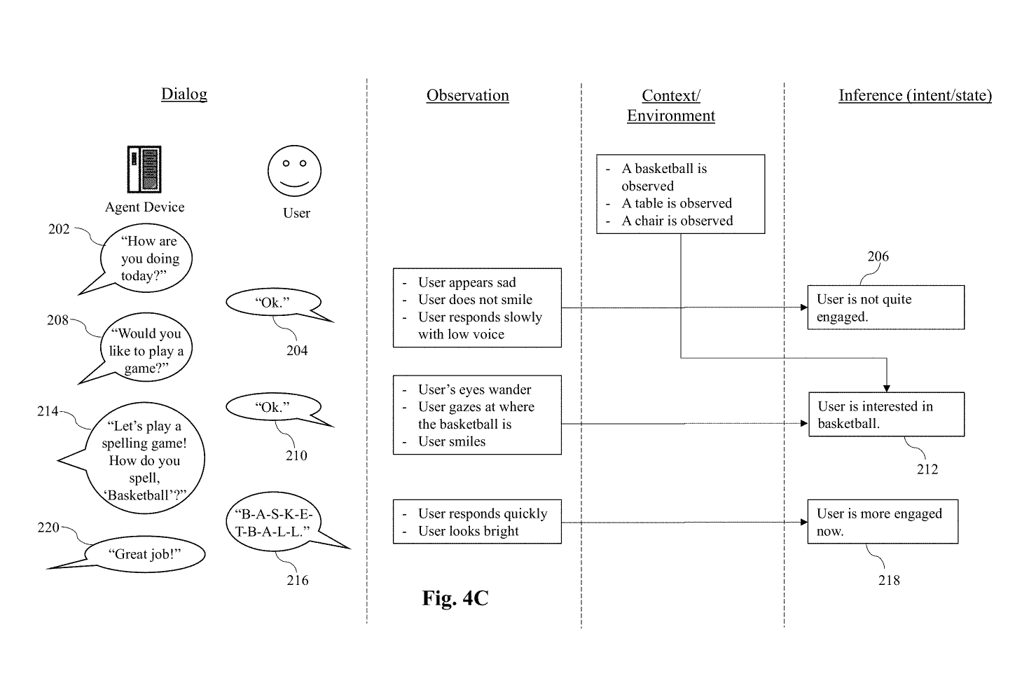

FIG. 4A depicts an exemplary high level system diagram for an overall system for the automated companion, according to various embodiments of the present teaching. In this illustrated embodiment, the overall system may encompass components/function modules residing in a user device, an agent device, and the user interaction engine 140. The overall system as depicted herein comprises a plurality of layers of processing and hierarchies that together carries out human-machine interactions in an intelligent manner. In the illustrated embodiment, there are 5 layers, including layer 1 for front end application as well as front end multi-modal data processing, layer 2 for characterizations of the dialog setting, layer 3 is where the dialog management module resides, layer 4 for estimated mindset of different parties (human, agent, device, etc.), layer 5 for so called utility. Different layers may correspond different levels of processing, ranging from raw data acquisition and processing at layer 1 to layer 5 on processing changing utilities of participants of dialogues.

The term “utility” is hereby defined as preferences of a party identified based on states detected associated with dialogue histories. Utility may be associated with a party in a dialogue, whether the party is a human, the automated companion, or other intelligent devices. A utility for a particular party may represent different states of a world, whether physical, virtual, or even mental. For example, a state may be represented as a particular path along which a dialog walks through in a complex map of the world. At different instances, a current state evolves into a next state based on the interaction between multiple parties. States may also be party dependent, i.e., when different parties participate in an interaction, the states arising from such interaction may vary. A utility associated with a party may be organized as a hierarchy of preferences and such a hierarchy of preferences may evolve over time based on the party's choices made and likings exhibited during conversations. Such preferences, which may be represented as an ordered sequence of choices made out of different options, is what is referred to as utility. The present teaching discloses method and system by which an intelligent automated companion is capable of learning, through a dialogue with a human conversant, the user's utility.

Within the overall system for supporting the automated companion, front end applications as well as front end multi-modal data processing in layer 1 may reside in a user device and/or an agent device. For example, the camera, microphone, keyboard, display, renderer, speakers, chat-bubble, and user interface elements may be components or functional modules of the user device. For instance, there may be an application or client running on the user device which may include the functionalities before an external application interface (API) as shown in FIG. 4A. In some embodiments, the functionalities beyond the external API may be considered as the backend system or reside in the user interaction engine 140. The application running on the user device may take multi-model data (audio, images, video, text) from the sensors or circuitry of the user device, process the multi-modal data to generate text or other types of signals (object such as detected user face, speech understanding result) representing features of the raw multi-modal data, and send to layer 2 of the system.

In layer 1, multi-modal data may be acquired via sensors such as camera, microphone, keyboard, display, speakers, chat bubble, renderer, or other user interface elements. Such multi-modal data may be analyzed to estimated or infer various features that may be used to infer higher level characteristics such as expression, characters, gesture, emotion, action, attention, intent, etc. Such higher level characteristics may be obtained by processing units at layer 2 and the used by components of higher layers, via the internal API as shown in FIG. 4A, to e.g., intelligently infer or estimate additional information related to the dialogue at higher conceptual levels. For example, the estimated emotion, attention, or other characteristics of a participant of a dialogue obtained at layer 2 may be used to estimate the mindset of the participant. In some embodiments, such mindset may also be estimated at layer 4 based on additional information, e.g., recorded surrounding environment or other auxiliary information in such surrounding environment such as sound.

The estimated mindsets of parties, whether related to humans or the automated companion (machine), may be relied on by the dialogue management at layer 3, to determine, e.g., how to carry on a conversation with a human conversant. How each dialogue progresses often represent a human user's preferences. Such preferences may be captured dynamically during the dialogue at utilities (layer 5). As shown in FIG. 4A, utilities at layer 5 represent evolving states that are indicative of parties' evolving preferences, which can also be used by the dialogue management at layer 3 to decide the appropriate or intelligent way to carry on the interaction.

Sharing of information among different layers may be accomplished via APIs. In some embodiments as illustrated in FIG. 4A, information sharing between layer 1 and rest of the layers is via an external API while sharing information among layers 2-5 is via an internal API. It is understood that this merely a design choice and other implementations are also possible to realize the present teaching presented herein. In some embodiments, through the internal API, various layers (2-5) may access information created by or stored at other layers to support the processing. Such information may include common configuration to be applied to a dialogue (e.g., character of the agent device is an avatar, voice preferred, or a virtual environment to be created for the dialogue, etc.), a current state of the dialogue, a current dialogue history, known user preferences, estimated user intent/emotion/mindset, etc. In some embodiments, some information that may be shared via the internal API may be accessed from an external database. For example, certain configurations related to a desired character for the agent device (a duck) may be accessed from, e.g., an open source database, that provide parameters (e.g., parameters to visually render the duck and/or parameters needed to render the speech from the duck).

FIG. 4B illustrates a part of a dialogue tree of an on-going dialogue with paths taken based on interactions between the automated companion and a user, according to an embodiment of the present teaching. In this illustrated example, the dialogue management at layer 3 (of the automated companion) may predict multiple paths with which a dialogue, or more generally an interaction, with a user may proceed. In this example, each node may represent a point of the current state of the dialogue and each branch from a node may represent possible responses from a user. As shown in this example, at node 1, the automated companion may face with three separate paths which may be taken depending on a response detected from a user. If the user responds with an affirmative response, dialogue tree 400 may proceed from node 1 to node 2. At node 2, a response may be generated for the automated companion in response to the affirmative response from the user and may then be rendered to the user, which may include audio, visual, textual, haptic, or any combination thereof.

If, at node 1, the user responses negatively, the path is for this stage is from node 1 to node 10. If the user responds, at node 1, with a “so-so” response (e.g., not negative but also not positive), dialogue tree 400 may proceed to node 3, at which a response from the automated companion may be rendered and there may be three separate possible responses from the user, “No response,” “Positive Response,” and “Negative response,” corresponding to nodes 5, 6, and 7, respectively. Depending on the user's actual response with respect to the automated companion's response rendered at node 3, the dialogue management at layer 3 may then follow the dialogue accordingly. For instance, if the user responds at node 3 with a positive response, the automated companion moves to respond to the user at node 6. Similarly, depending on the user's reaction to the automated companion's response at node 6, the user may further respond with an answer that is correct. In this case, the dialogue state moves from node 6 to node 8, etc. In this illustrated example, the dialogue state during this period moved from node 1, to node 3, to node 6, and to node 8. The traverse through nodes 1, 3, 6, and 8 forms a path consistent with the underlying conversation between the automated companion and a user. As seen in FIG. 4B, the path representing the dialogue is represented by the solid lines connecting nodes 1, 3, 6, and 8, whereas the paths skipped during a dialogue is represented by the dashed lines.

FIG. 4C illustrates exemplary a human-agent device interaction and exemplary processing performed by the automated companion, according to an embodiment of the present teaching. As seen from FIG. 4C, operations at different layers may be conducted and together they facilitate intelligent dialogue in a cooperated manner. In the illustrated example, an agent device may first ask a user “How are you doing today?” at 402 to initiate a conversation. In response to utterance at 402, the user may respond with utterance “Ok” at 404. To manage the dialogue, the automated companion may activate different sensors during the dialogue to make observation of the user and the surrounding environment. For example, the agent device may acquire multi-modal data about the surrounding environment where the user is in. Such multi-modal data may include audio, visual, or text data. For example, visual data may capture the facial expression of the user. The visual data may also reveal contextual information surrounding the scene of the conversation. For instance, a picture of the scene may reveal that there is a basketball, a table, and a chair, which provides information about the environment and may be leveraged in dialogue management to enhance engagement of the user. Audio data may capture not only the speech response of the user but also other peripheral information such as the tone of the response, the manner by which the user utters the response, or the accent of the user.

Based on acquired multi-modal data, analysis may be performed by the automated companion (e.g., by the front end user device or by the backend user interaction engine 140) to assess the attitude, emotion, mindset, and utility of the users. For example, based on visual data analysis, the automated companion may detect that the user appears sad, not smiling, the user's speech is slow with a low voice. The characterization of the user's states in the dialogue may be performed at layer 2 based on multi-model data acquired at layer 1. Based on such detected observations, the automated companion may infer (at 406) that the user is not that interested in the current topic and not that engaged. Such inference of emotion or mental state of the user may, for instance, be performed at layer 4 based on characterization of the multi-modal data associated with the user.

To respond to the user's current state (not engaged), the automated companion may determine to perk up the user in order to better engage the user. In this illustrated example, the automated companion may leverage what is available in the conversation environment by uttering a question to the user at 408: “Would you like to play a game?” Such a question may be delivered in an audio form as speech by converting text to speech, e.g., using customized voices individualized for the user. In this case, the user may respond by uttering, at 410, “Ok.” Based on the continuously acquired multi-model data related to the user, it may be observed, e.g., via processing at layer 2, that in response to the invitation to play a game, the user's eyes appear to be wandering, and in particular that the user's eyes may gaze towards where the basketball is located. At the same time, the automated companion may also observe that, once hearing the suggestion to play a game, the user's facial expression changes from “sad” to “smiling.” Based on such observed characteristics of the user, the automated companion may infer, at 412, that the user is interested in basketball.

Based on the acquired new information and the inference based on that, the automated companion may decide to leverage the basketball available in the environment to make the dialogue more engaging for the user yet still achieving the educational goal for the user. In this case, the dialogue management at layer 3 may adapt the conversion to talk about a game and leverage the observation that the user gazed at the basketball in the room to make the dialogue more interesting to the user yet still achieving the goal of, e.g., educating the user. In one example embodiment, the automated companion generates a response, suggesting the user to play a spelling game” (at 414) and asking the user to spell the word “basketball.”

Given the adaptive dialogue strategy of the automated companion in light of the observations of the user and the environment, the user may respond providing the spelling of word “basketball.” (at 416). Observations are continuously made as to how enthusiastic the user is in answering the spelling question. If the user appears to respond quickly with a brighter attitude, determined based on, e.g., multi-modal data acquired when the user is answering the spelling question, the automated companion may infer, at 418, that the user is now more engaged. To further encourage the user to actively participate in the dialogue, the automated companion may then generate a positive response “Great job!” with instruction to deliver this response in a bright, encouraging, and positive voice to the user.

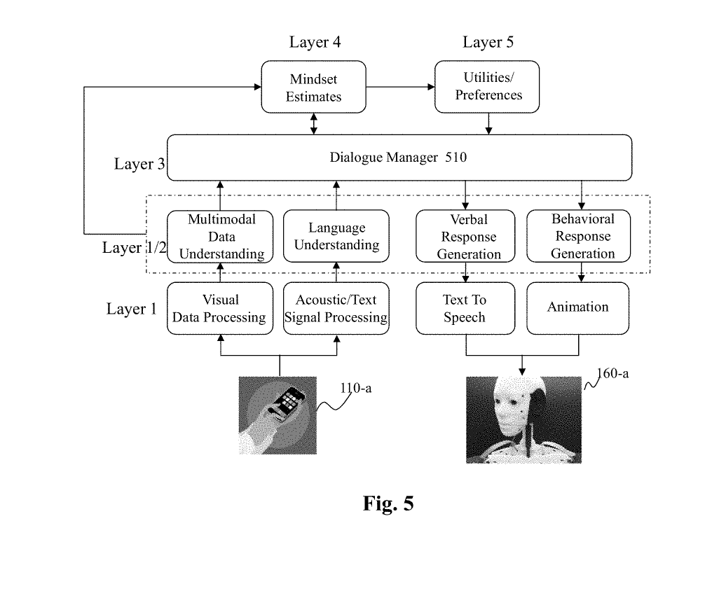

FIG. 5 illustrates exemplary communications among different processing layers of an automated dialogue companion centered around a dialogue manager 510, according to various embodiments of the present teaching. The dialogue manager 510 in FIG. 5 corresponds to a functional component of the dialogue management at layer 3. A dialog manager is an important part of the automated companion and it manages dialogues. Traditionally, a dialogue manager takes in as input a user's utterances and determine how to respond to the user. This is performed without taking into account the user's preferences, user's mindset/emotions/intent, or surrounding environment of the dialogue, i.e., given any weights to the different available states of the relevant world. The lack of an understanding of the surrounding world often limits the perceived authenticity of or engagement in the conversations between a human user and an intelligent agents.

In some embodiments of the present teaching, the utility of parties of a conversation relevant to an on-going dialogue is exploited to allow a more personalized, flexible, and engaging conversion to be carried out. It facilitates an intelligent agent acting in different roles to become more effective in different tasks, e.g., scheduling appointments, booking travel, ordering equipment and supplies, and researching online on various topics. When an intelligent agent is aware of a user's dynamic mindset, emotions, intent, and/or utility, it enables the agent to engage a human conversant in the dialogue in a more targeted and effective way. For example, when an education agent teaches a child, the preferences of the child (e.g., color he loves), the emotion observed (e.g., sometimes the child does not feel like continue the lesson), the intent (e.g., the child is reaching out to a ball on the floor instead of focusing on the lesson) may all permit the education agent to flexibly adjust the focus subject to toys and possibly the manner by which to continue the conversation with the child so that the child may be given a break in order to achieve the overall goal of educating the child.

As another example, the present teaching may be used to enhance a customer service agent in its service by asking questions that are more appropriate given what is observed in real-time from the user and hence achieving improved user experience. This is rooted in the essential aspects of the present teaching as disclosed herein by developing the means and methods to learn and adapt preferences or mindsets of parties participating in a dialogue so that the dialogue can be conducted in a more engaging manner.

Dialogue manager (DM) 510 is a core component of the automated companion. As shown in FIG. 5, DM 510 (layer 3) takes input from different layers, including input from layer 2 as well as input from higher levels of abstraction such as layer 4 for estimating mindsets of parties involved in a dialogue and layer 5 that learns utilities/preferences based on dialogues and assessed performances thereof. As illustrated, at layer 1, multi-modal information is acquired from sensors in different modalities which is processed to, e.g., obtain features that characterize the data. This may include signal processing in visual, acoustic, and textual modalities.

Such multi-modal information may be acquired by sensors deployed on a user device, e.g., 110-a during the dialogue. The acquired multi-modal information may be related to the user operating the user device 110-a and/or the surrounding of the dialogue scene. In some embodiments, the multi-model information may also be acquired by an agent device, e.g., 160-a, during the dialogue. In some embodiments, sensors on both the user device and the agent device may acquire relevant information. In some embodiments, the acquired multi-model information is processed at Layer 1, as shown in FIG. 5, which may include both a user device and an agent device. Depending on the situation and configuration, Layer 1 processing on each device may differ. For instance, if a user device 110-a is used to acquire surround information of a dialogue, including both information about the user and the environment around the user, raw input data (e.g., text, visual, or audio) may be processed on the user device and then the processed features may then be sent to Layer 2 for further analysis (at a higher level of abstraction). If some of the multi-modal information about the user and the dialogue environment is acquired by an agent device, the processing of such acquired raw data may also be processed by the agent device (not shown in FIG. 5) and then features extracted from such raw data may then be sent from the agent device to Layer 2 (which may be located in the user interaction engine 140).

Layer 1 also handles information rendering of a response from the automated dialogue companion to a user. In some embodiments, the rendering is performed by an agent device, e.g., 160-a and examples of such rendering include speech, expression which may be facial or physical acts performed. For instance, an agent device may render a text string received from the user interaction engine 140 (as a response to the user) to speech so that the agent device may utter the response to the user. In some embodiments, the text string may be sent to the agent device with additional rendering instructions such as volume, tone, pitch, etc. which may be used to convert the text string into a sound wave corresponding to an utterance of the content in a certain manner. In some embodiments, a response to be delivered to a user may also include animation, e.g., utter a response with an attitude which may be delivered via, e.g., a facial expression or a physical act such as raising one arm, etc. In some embodiments, the agent may be implemented as an application on a user device. In this situation, rendering of a response from the automated dialogue companion is implemented via the user device, e.g., 110-a (not shown in FIG. 5).

Processed features of the multi-modal data may be further processed at layer 2 to achieve language understanding and/or multi-modal data understanding including visual, textual, and any combination thereof. Some of such understanding may be directed to a single modality, such as speech understanding, and some may be directed to an understanding of the surrounding of the user engaging in a dialogue based on integrated information. Such understanding may be physical (e.g., recognize certain objects in the scene), perceivable (e.g., recognize what the user said, or certain significant sound, etc.), or mental (e.g., certain emotion such as stress of the user estimated based on, e.g., the tune of the speech, a facial expression, or a gesture of the user).

The multimodal data understanding generated at layer 2 may be used by DM 510 to determine how to respond. To enhance engagement and user experience, the DM 510 may also determine a response based on the estimated mindsets of the user and of the agent from layer 4 as well as the utilities of the user engaged in the dialogue from layer 5. The mindsets of the parties involved in a dialogue may be estimated based on information from Layer 2 (e.g., estimated emotion of a user) and the progress of the dialogue. In some embodiments, the mindsets of a user and of an agent may be estimated dynamically during the course of a dialogue and such estimated mindsets may then be used to learn, together with other data, utilities of users. The learned utilities represent preferences of users in different dialogue scenarios and are estimated based on historic dialogues and the outcomes thereof.

In each dialogue of a certain topic, the dialogue manager 510 bases its control of the dialogue on relevant dialogue tree(s) that may or may not be associated with the topic (e.g., may inject small talks to enhance engagement). To generate a response to a user in a dialogue, the dialogue manager 510 may also consider additional information such as a state of the user, the surrounding of the dialogue scene, the emotion of the user, the estimated mindsets of the user and the agent, and the known preferences of the user (utilities).

An output of DM 510 corresponds to an accordingly determined response to the user. To deliver a response to the user, the DM 510 may also formulate a way that the response is to be delivered. The form in which the response is to be delivered may be determined based on information from multiple sources, e.g., the user's emotion (e.g., if the user is a child who is not happy, the response may be rendered in a gentle voice), the user's utility (e.g., the user may prefer speech in certain accent similar to his parents'), or the surrounding environment that the user is in (e.g., noisy place so that the response needs to be delivered in a high volume). DM 510 may output the response determined together with such delivery parameters.

In some embodiments, the delivery of such determined response is achieved by generating the deliverable form(s) of each response in accordance with various parameters associated with the response. In a general case, a response is delivered in the form of speech in some natural language. A response may also be delivered in speech coupled with a particular nonverbal expression as a part of the delivered response, such as a nod, a shake of the head, a blink of the eyes, or a shrug. There may be other forms of deliverable form of a response that is acoustic but not verbal, e.g., a whistle.

To deliver a response, a deliverable form of the response may be generated via, e.g., verbal response generation and/or behavior response generation, as depicted in FIG. 5. Such a responses in its determined deliverable form(s) may then be used by a renderer to actual render the response in its intended form(s). For a deliverable form in a natural language, the text of the response may be used to synthesize a speech signal via, e.g., text to speech techniques, in accordance with the delivery parameters (e.g., volume, accent, style, etc.). For any response or part thereof, that is to be delivered in a non-verbal form(s), e.g., with a certain expression, the intended non-verbal expression may be translated into, e.g., via animation, control signals that can be used to control certain parts of the agent device (physical representation of the automated companion) to perform certain mechanical movement to deliver the non-verbal expression of the response, e.g., nodding head, shrug shoulders, or whistle. In some embodiments, to deliver a response, certain software components may be invoked to render a different facial expression of the agent device. Such rendition(s) of the response may also be simultaneously carried out by the agent (e.g., speak a response with a joking voice and with a big smile on the face of the agent).

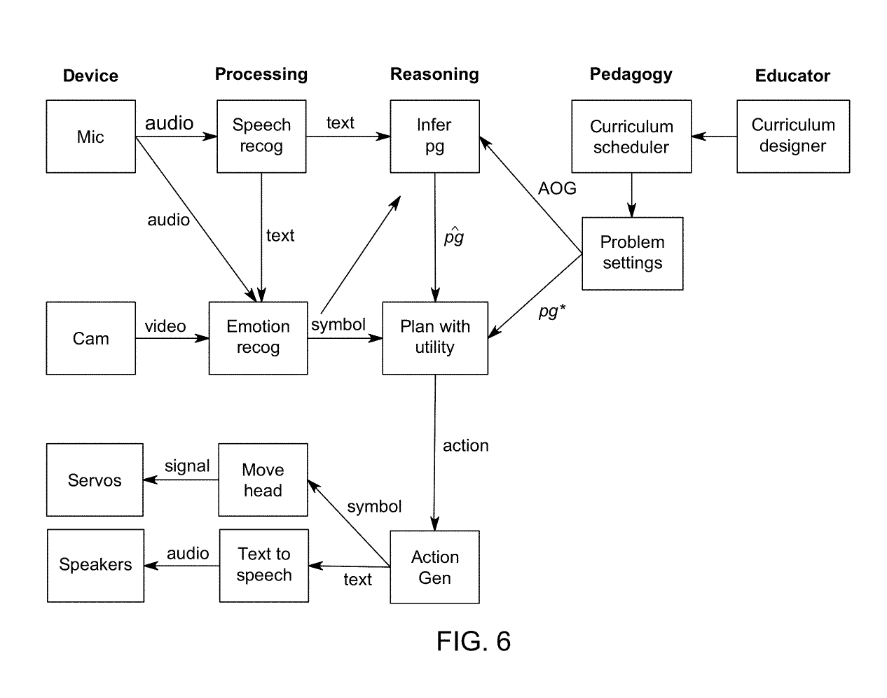

FIG. 6 depicts an exemplary high level system diagram for an artificial intelligence based educational companion, according to various embodiments of the present teaching. In this illustrated embodiment, there are five levels of processing, namely device level, processing level, reasoning level, pedagogy or teaching level, and educator level. The device level comprising sensors such as microphone and camera or media delivery devices such as servos to move, e.g., body parts of a robot or speakers to deliver dialogue content. The processing level comprises various processing components directed to processing of different types of signals, which include both input and output signals.

On the input side, the processing level may include speech processing module for performing, e.g., speech recognition based on audio signal obtained from an audio sensor (microphone) to understand what is being uttered in order to determine how to respond. The audio signal may also be recognized to generate text information for further analysis. The audio signal from the audio sensor may also be used by an emotion recognition processing module. The emotion recognition module may be designed to recognize various emotions of a party based on both visual information from a camera and the synchronized audio information. For instance, a happy emotion may often be accompanied with a smile face and a certain acoustic cues. The text information obtained via speech recognition may also be used by the emotion recognition module, as a part of the indication of the emotion, to estimate the emotion involved.

On the output side of the processing level, when a certain response strategy is determined, such strategy may be translated into specific actions to take by the automated companion to respond to the other party. Such action may be carried out by either deliver some audio response or express certain emotion or attitude via certain gesture. When the response is to be delivered in audio, text with words that need to be spoken are processed by a text to speech module to produce audio signals and such audio signals are then sent to the speakers to render the speech as a response. In some embodiments, the speech generated based on text may be performed in accordance with other parameters, e.g., that may be used to control to generate the speech with certain tones or voices. If the response is to be delivered as a physical action, such as a body movement realized on the automated companion, the actions to be taken may also be instructions to be used to generate such body movement. For example, the processing level may include a module for moving the head (e.g., nodding, shaking, or other movement of the head) of the automated companion in accordance with some instruction (symbol). To follow the instruction to move the head, the module for moving the head may generate electrical signal, based on the instruction, and send to servos to physically control the head movement.

The third level is the reasoning level, which is used to perform high level reasoning based on analyzed sensor data. Text from speech recognition, or estimated emotion (or other characterization) may be sent to an inference program which may operate to infer various high level concepts such as intent, mindset, preferences based on information received from the second level. The inferred high level concepts may then be used by a utility based planning module that devises a plan to respond in a dialogue given the teaching plans defined at the pedagogy level and the current state of the user. The planned response may then be translated into an action to be performed to deliver the planned response. The action is then further processed by an action generator to specifically direct to different media platform to carry out the intelligent response.

The pedagogy and educator levels both related to the educational application as disclosed. The educator level includes activities related to designing curriculums for different subject matters. Based on designed curriculum, the pedagogy level includes a curriculum scheduler that schedules courses based on the designed curriculum and based on the curriculum schedule, the problem settings module may arrange certain problems settings be offered based on the specific curriculum schedule. Such problem settings may be used by the modules at the reasoning level to assist to infer the reactions of the users and then plan the response accordingly based on utility and inferred state of mind.

In some dialogue applications, voice or text input may be used to create a scene as depicted in the voice input. For instance, a user may utter a sentence or types some text with certain description of a scene, then a computer system analyzes the input (either oral or text) and understands the semantics expressed therein and creates a visual scene consistent with the semantics in response to the uttered or typed text. What appears in the visual scene or what is being rendered in the visual scene corresponds to the content of what the user said or typed. For example, in a user machine dialogue session, a user may describe, either orally or by texting, a scene, e.g., “Five geese are running across the lawn.” In this description, the background is a lawn possibly with trees or fences around, the subjects are the geese, and the action is that these geese are running across the lawn. Based on such semantic understanding of what is being said/conveyed, a visual scene may be rendered with a lawn present and five geese rendered in a way that seems that they are crossing the lawn.

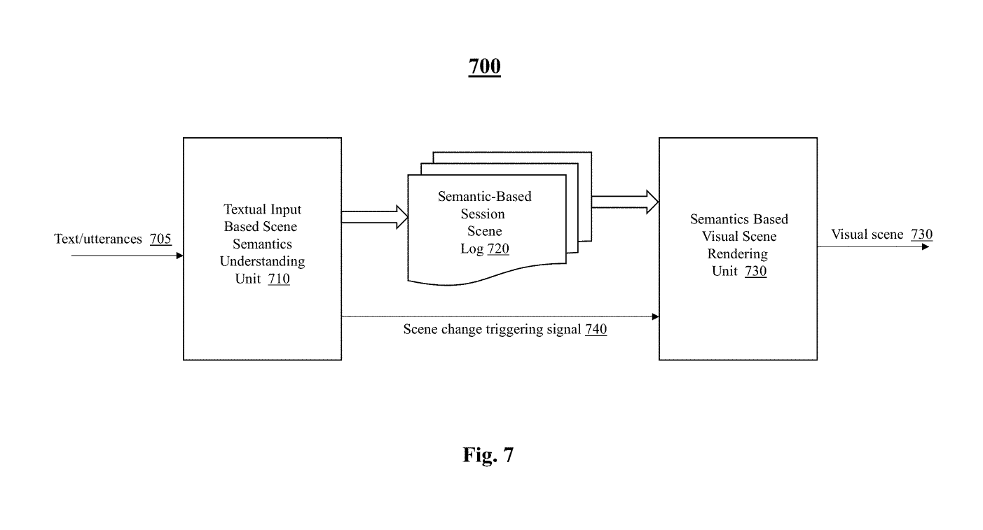

The present teaching discloses method, system, and implementations to render a visual scene based on semantics of an input, which may be a voice input or a textual input. FIG. 7 illustrates a framework 700 for rendering a visual scene based on textual input from a user, according to embodiments of the present teaching. In this illustrated embodiment, the textual input may correspond to either typed text or an utterance from a user and may be provided as the basis for creating a visual scene accordingly. When the input is in an acoustic form, it may first be processed and converted into textual form via speech processing. As shown, the framework 700 comprises a textual input based scene semantics understanding unit 710 and a semantics based visual scene rendering unit 730. Based on the input, the textual input based scene semantics understanding unit 710 processes the input, performs linguistic analysis to understand various semantics expressed, explicitly or implicitly in the input, and generates a semantic-based session scene log and stores it in storage 720. Such a scene log includes a scene representation for each scene and an entry for each scene may describe semantic relationships among different entities in order to enable visualization of a scene that fits the description of the input 705. Based on the semantic-based session scene log 720, the semantic-based visual scene rendering unit 730 renders a visual scene that is in accordance with the intent of the user who provided the input 705.

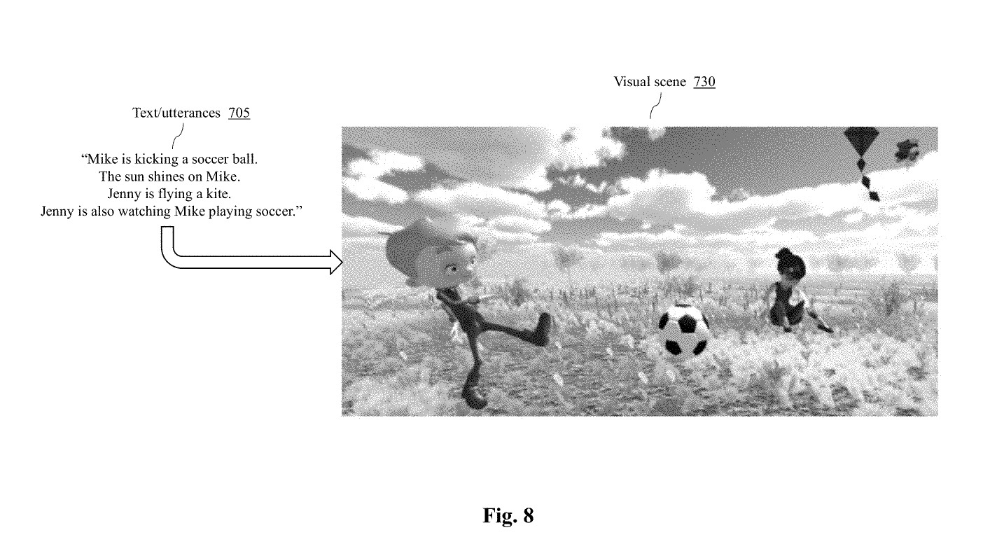

FIG. 8 shows an example of a visual scene 730 rendered based on input from a user, according to an embodiment of the present teaching. As seen, a user provides an input 705 which may be directly in text or simply utterance of sentences describing a scene. In this example, the input has three sentences: (1) “Mike is kicking a soccer ball,” (2) “The sun shines on Mike” (3) “Jenny is flying a kite,” and (4) “Jenny is also watching Mike playing soccer.” From these input sentences (possibly transformed from utterances via speech processing), the visual scene 730 created includes various entities rendered, such as a field scene (because the input implied that it is outdoor in order to play soccer and fly a kite) as the background, a boy (Mike), a soccer (because the input says that someone is playing soccer), a girl (Jenny), a kite (because the input says that someone is flying a kite).

The entities rendered are arranged spatially in accordance with the semantics of the input 705. For instance, the boy and the soccer are apart with a certain distance because the input says that Mike is kicking a soccer ball. The kite is in the spatial space in the image that corresponds to the sky because a kite is supposed to fly high. The girl is also at some position that is apart from the boy because she not only is flying a kite but also watching the boy playing the soccer call. The scene may also be rendered to satisfy certain functional relationship among different entities. For instance, the input sentence “The sun shines on Mike” may be processed to render that some parts (part of his hair, part of his face, and one shoe) of Mike may be rendered brighter than other remaining parts of Mike to show sunlight shinning from one consistent direction of the sky rendered.

The entities visualized in the visual scene may also be rendered to satisfy other criteria that are implied by the input 705. For example, in some situations, certain attributes of an entity may need to be rendered in a way that have to align with some other entities in order to satisfy the semantics of the input. For instance, as the input says that “Mike is kicking a soccer ball,” the ball may need to be rendered in the middle of the air (e.g., not on the ground level) and the boy may need to be rendered in a way that one of his legs is raised (because he is kicking) and pointing in a direction of the kicked ball. That is, one attribute of the boy (the leg) needs to be aligned with some other entity or an attribute thereof in order to meet the requirements of the semantics expressed.

Referring back to FIG. 7, the textual input based scene semantics understanding unit 710 is to analyze the input 705 and generates the semantic based session scene log 720. In some embodiments, the scene log 720 may be organized based on dialogue sessions and in each dialogue session, there may be multiple scenes to be rendered under different input instructions. The instructions about each scene may be from a user engaged in the dialogue with the automated dialogue companion or from the automated dialogue companion that generates the instruction based on, e.g., interests of a user engaged in a dialogue with it or the content of the dialogue. For instance, if during a dialogue, the user engaged in the dialogue states something he really likes (e.g., play volley ball on a beach) and appears to be distracted, the automated dialogue companion may decide to relax the user in order to continue to engage the user by generating an instruction to render a beach scene with a person playing sports at the beach. Once the user calms down and relaxed, the automated dialogue companion may then go back to the subject matter of the dialogue, e.g., educational program on math, by resuming the initially planned scene (e.g., a blackboard with math problems). Thus, during the same dialogue, the scene may change dynamically based on instructions and different scenes associated with a same dialogue may be organized in a session based log.

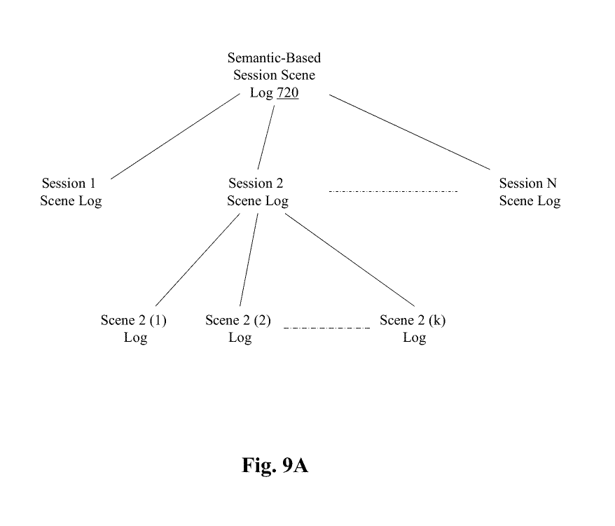

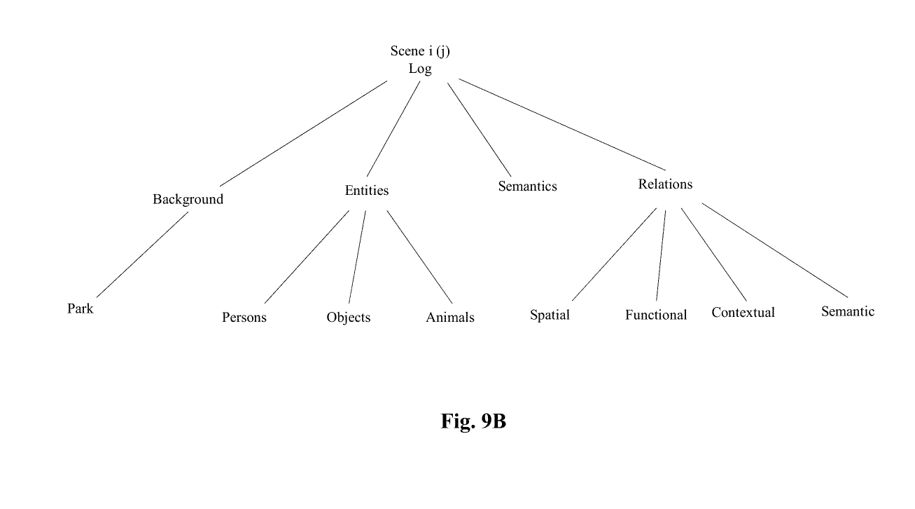

FIG. 9A illustrates an exemplary construct of a semantic-based session scene log 720, according to an embodiment of the present teaching. As shown, in this illustrated construct, the semantic-based session scene log 720 may include session scene logs organized based on sessions, e.g., session 1 scene log, session 2 scene log, . . . , session N scene log. For each session, there may be multiple scenes, each of which is represented as a scene log corresponding to a time frame. For instance, for a dialogue session 2, its scene log may include multiple scenes corresponding to the scene log for scene 2 at different time frames or denoted as scene 2(1) log (the scene log for scene during time frame 1 in session 2), scene 2(2) (the scene log for scene in session 2 during time frame 2), . . . , and scene 2(k) log (the scene log for scene during time frame k in session 2).

FIG. 9B illustrates an exemplary organization and content of a log for a specific scene in the semantic-based session scene log 720, according to an embodiment of the present teaching. As illustrated, this exemplary log for a scene (scene i(j) log) includes descriptions of various parts of a scene to be rendered, including the background of the scene, entities to appear in the scene, descriptions of relevant semantics and relationships. For instance, the background may be described as one of a plurality of staple scenes such as a park. For example, in FIG. 8, as the scene is described in relation to certain activities outdoors including playing soccer and kite, the background selected is a scene with grass field and sky with sunshine. The entities may include a person, an object (desk), . . . , and an animal. As another example, if an input says “David is playing a Lego game in his bedroom,” then the background determined based on this input may be a bedroom setting.

A scene log may also include entities to be rendered in the scene. Such entities may be explicitly named in the input or in some situations implied. For instance, the entities explicitly required based on the input 705 in FIG. 8 include a boy, a girl, a ball, and a kite. But the scene may also need to include other entities. For instance, as the input requires that “the sun shines on Mike,” it may be inferred that the sky must have sunshine and cannot be all gray. In addition, as the sun has to shine on Mike, although the sun does not need to be rendered, the light from the sun implicitly needs to be rendered in a direction that will intersect with Mike.

The relationships may include spatial, functional, contextual, and semantic relations. The spatial relation may involve a description of how entities to be rendered in the scene should be spatially arranged to enable activities described in the input, e.g., the positions to render the boy, the ball, the girl, the kite need to be set up so that they support the activities such as kicking the ball and flying kite in relation to the ground and sky in the background as shown in FIG. 8. The functional relation may include that different entities may need to be rendered in such a way that they can fulfill the functional roles as dictated by the input. For instance, if the input requires “the sun shines on Mike,” then the rendering of the sunlight and Mike needs to be done in a way that shows that, e.g., the brighter part of the sky needs to be on the side of the scene that is consistent with the parts of Mike that are also brighter.

In some situations, the input may specify certain contextual information that may also require the scene to be rendered in a way that satisfy the contextual relationship between/among different entities. For instance, in the input illustrated in FIG. 8, it is stated that “Jenny is also watching Mike playing soccer.” In this case, not only Jenny needs to be rendered to be related to playing kite but also needs to face Mike in order to fulfill the contextual relationship that she is also watching Mike. In some embodiments, specific semantics of the input may also play a role as to how to render a visual scene by coordinating the rendering of different parts of different entities in order to satisfy the semantics expressed in the input 705. As discussed herein, when the input says “Mike is kicking a soccer ball,” the semantics of this input require that one foot of Mike needs to be rendered so that it is aligned in the direction of the soccer ball.

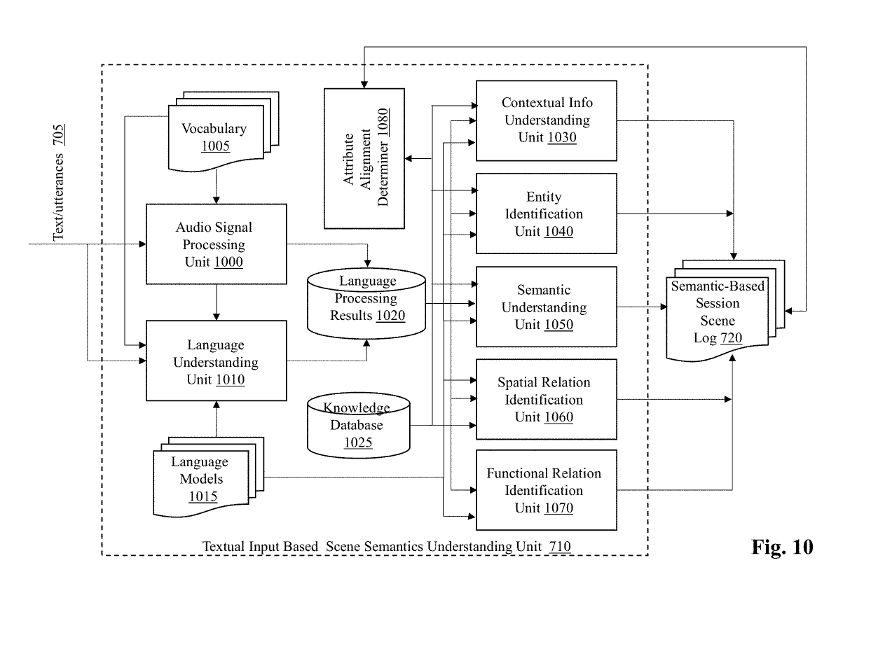

FIG. 10 depicts an exemplary high level system diagram of the textual input based scene semantics understanding unit 710, according to an embodiment of the present teaching. This exemplary embodiment includes components that can be used to handle either textual input or acoustic input (utterance). The exemplary textual input based scene semantics understanding unit 710 comprises an audio signal processing unit 1000, a language understanding unit 1010, and a plurality of components that analyze text information (either from input or recognized from the utterance) and identify various types of semantic information that are relevant to rendering a corresponding visual scene. For instance, in this illustrated embodiment, these components include a contextual information understanding unit 1030, an entity identification unit 1040, a semantic understanding unit 1050, a spatial relation identification unit 1060, a functional relation identification unit 1070, and an attribute alignment determiner 1080.

As discussed herein, the input 705 may be typed text or an acoustic signal representing an utterance orally describing a scene. For an acoustic signal representing an utterance, the audio signal processing unit 1000 processes the audio signal to recognize, e.g., words spoken, based on vocabulary 1005. The recognized words form a recognized text string and are sent to the language understanding unit 1010 for language understanding based on language models 1015. When the input 705 corresponds to typed text, such input text may be sent directly to the language understanding unit 1010. Based on language models 1015, the language understanding unit 1010 may extract syntactically distinct components such as subject, verb, direct object, indirect object, adjectives, or adverbs, names, places, times, etc. Such extracted syntactically distinct components may be stored in 1020 as language processing results and can be used by other processing units to further understand different aspects of the underlying semantics of the input.

The semantic understanding unit 1050 may be provided to understand the semantics of the input based on the language processing results stored in 1020 and information stored in a knowledge database 1025. For instance, from the exemplary input 705 shown in FIG. 8, the semantic understanding unit 1050 may conclude that the scene is outdoor (because of language playing soccer and flying kite) and has sunshine (because of the requirement that the sun shines on someone), there are different entities involved which may be related in certain ways, and these entities may carry out certain activities (e.g., kicking a soccer ball) that may have impact on each other, etc. Such semantics may then be further used by other components to extract specific types of information that may affect the rendering.

The entity identification unit 1040 is provided to identify any entity recited in the text, including a person (name), an animal, an object (ball), etc. and that need to be rendered in the visual scene. The language models 1015 may provide definitions of different types of entities in a text string and can be used by the entity identification unit 1040 to identify the entities in a given input. The spatial relation identification unit 1060 is provided to identify any spatial relations between or among the identified entities that can be inferred from the input based on the semantics. Using the example shown in FIG. 8, given the semantics of the input require that Mike kick the ball, the spatial relation identification unit 1060 may infer that these two entities need to be spatially apart. Similarly, based on the same semantic understanding of the input, the functional relation identification unit 1070 may infer that when Mike is rendered, one of his feet needs to be rendered as lifted and pointing to the direction of the soccer ball rendered. Other spatial and functional relations may also be inferred, e.g., the spatial arrangement between sun light and Mike because the input requires that the sun shines on Mike.

The contextual relation identification unit 1030 may infer various context of the visual scene based on the input. For instance, from input “Mike is kicking a soccer ball,” the contextual relation identification unit 1030 may infer that the scene to be rendered is an outdoor scene. In addition, from “The sun shines on Mike,” it may be inferred that it is a day time scene and not raining. The attribute alignment determiner 1080 may also rely on the language processing results from 1020 and the knowledge from 1025 to infer how attributes of entities to be rendered need to be aligned to satisfy the semantics of the input. Taking the example shown in FIG. 8, as the input requires that “Jenny is also watching Mike playing soccer,” the attribute alignment determiner 1080 may infer that Jenny has to be rendered facing Mike, i.e., the attributes of Jenny's face and body need to be aligned or oriented in the direction Mike is rendered. Such parameters related to how to visualize a scene as described by given input, once inferred based on the semantics of the input, are then stored in the semantic-based session scene log 720, which will be used by the semantics based visual scene rendering unit 730, as shown in FIG. 7.

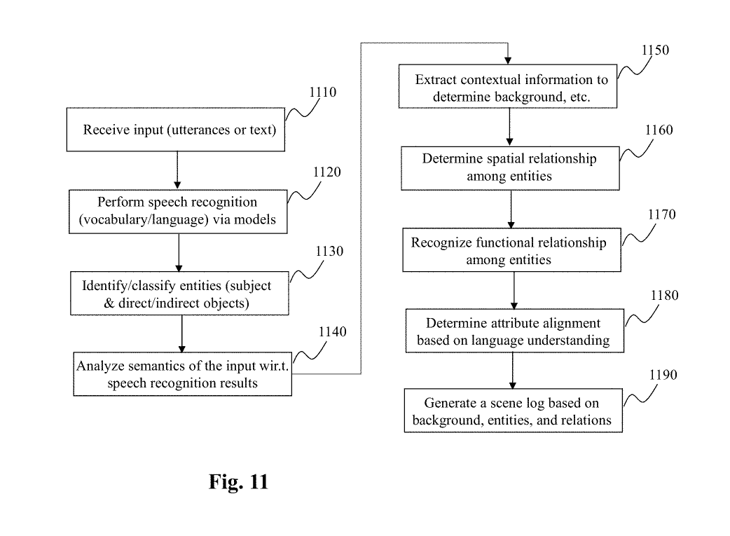

FIG. 11 is a flowchart of an exemplary process of the textual input based scene semantics understanding unit 710, according to an embodiment of the present teaching. At 1110, input 705, either in audio form or in textual form, is received. If it is in audio form, the audio signal processing unit 1000 analyzes the audio signal to recognize words spoken based on the vocabulary 1005. The word string, either from audio processing unit 1000 or directly from the input 705, is analyzed based on the language models 1015 to perform, at 1120, speech recognition such as identifying various syntactic components from the word string and save the language processing results in 1020. Based on the language processing results, the entity identification unit 1040 identifies, at 1130, entities present in the input and classify such detected entities. The semantic understanding unit 1050 analyzes, at 1140, the language processing results to interpret the semantics of the input.

Similarly, based on the language processing results, the contextual information understanding unit 1030 extracts, at 1150, relevant context information and determine background of the scene to be visualized. For identified entities, the spatial relation identification unit 1060 determines, at 1160, spatial relationships between and among different entities in the scene based on the semantics of the input as well as knowledge stored in the knowledge database 1025. In addition to the spatial arrangement of entities involved in the scene, the functional relation identification unit 1070 recognizes, at 1170, functional relations between and among different entities that need to be present in order to visualize the semantics of the input. Such detected semantics, entities, relations in accordance with the input are then used to generate, at 1190, the scene log associated with the input, which is then saved in the semantic-based session scene log storage 720.

Once the semantic-based session scene log is stored, it can be used by the semantics-based visual scene rendering unit 730 to render the scene. As discussed herein, in some embodiments, for each dialogue session, scenes may change during the course of the dialogue and each scene may be associated with a time frame so that the rendering unit 730 may observe to render each scene for a designated period of time. In other embodiments, the lasting time frame for each scene in a session may not be made known until the scene changes. For instance, depending on the development of the dialogue, either the user engaged in the dialogue scene or the automated dialogue companion may decide to change the scene based on the dynamics of the conversation. In this case, as shown in FIG. 7, the textual input based scene semantics understanding unit 710 may send a scene change triggering signal 740 to the semantic base visual scene rendering unit 730 so that the rendering unit 730 may proceed to access the semantic-based session scene log 720 for log representing the most recent scene of the dialogue session.

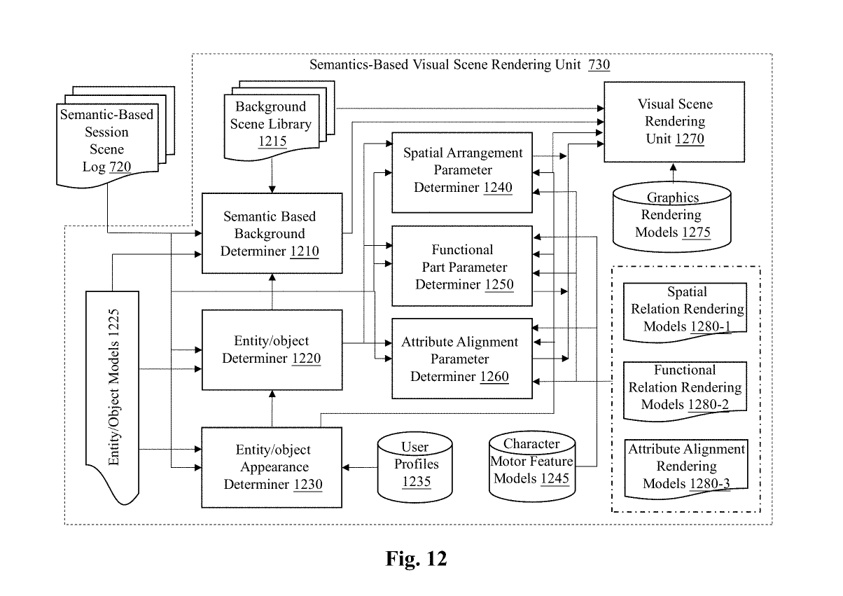

To render a visual scene, the semantic-based visual scene rendering unit 730 may access the scene log representing the scene and visualize the scene accordingly. FIG. 12 depicts an exemplary high level system diagram of the semantics-based visual scene rendering unit 730, according to an embodiment of the present teaching. In this illustrated embodiment, the semantics-based visual scene rendering unit 730 may first determine and set up the background of the visual scene and entities that will appear in the scene based on the semantic-based session scene log 720. With all the things (subject, object, items, background) to appear in the scene are determiner, the semantics-based visual scene rendering unit 730 may then determine how each and every of the things to be rendered should be rendered based on the semantics of the input. This may include where to position different entities/items in the scene, what conditions need to be satisfied during rendering with respect to each entity/item, the relations that need to be preserved in between or among entities, and how features related to different entities need to be adjusted in order to deliver the semantics of the input.

To determine entities/items/background to be included in the scene, the semantics-based visual scene rendering unit 730 includes a semantic based background determiner 1210, an entity/object determiner 1220, and an entity appearance determiner 1230. The semantic based background determiner 1210 may access the relevant scene log in 720 and select, from a background scene library 1215, an appropriate background scene for the rendering. For example, taking the example shown in FIG. 8, if it is known from the semantics of the input that the background needs to be a sunny (the sun has to shine on an entity) outdoor (playing soccer and flying kite both require outdoor) scene with a lawn (for playing soccer) and some sky space (for flying the kite), the semantic-based background determiner 1210 may select from a plurality of outdoor scenes in 1215 the one that is consistent with the semantics of the input. For instance, although there may be multiple outdoor scenes that have sunny sky and lawn, some may have too many trees which may not be desirable for playing kite.

The entity/object determiner 1220 may be provided to select, from entity models in 1225, appropriate characters for the required entities. For example, based on the input shown in FIG. 8, there may be four entities/objects, e.g., Mike, Jenny, soccer ball, and kite. For each of such entities/objects, the entity/object determiner 1220 may select specific entity/object model for the rendering based on the semantics of the input 705. For example, name “Mike” indicates that the entity is a man/boy. Similar selection may be determined based on name “Jenny,” i.e., a girl/woman should be selected as the model to render “Jenny.” To further disambiguate whether the selections should be a man or boy or a woman or a girl, additional contextual information or certain assumptions may be relied on. For instance, if the automated dialogue companion is conducting the dialogue with a user who is known to be a child, then the selections may be a boy for “Mike” and a girl for “Jenny.” In a similar fashion, objects “soccer ball” and “kite” may be selected from the entity/object models 1225.

Contextual information or user information may be used to further refine, by the entity appearance determiner 1230, parameters to be used to render the appearances of the entities/objects. As shown, the entity appearance determiner 1230 may access information from a user profile database 1235 to determine, e.g., the specific characteristics or features of each entity/object. For instance, if the user engaged in the dialogue is known to be a blond Caucasian boy with blue eyes and red shirt (e.g., observed by the automated dialogue companion during the dialogue), these features may be used to render the entity representing “Mike.” Similarly, if it is known that Mike likes certain type of soccer ball, such information may be retrieved from the user profile and used to render the soccer ball. In some embodiments, a background selected by the semantic based background determiner 1210 may also include certain objects such as sky, clouds, trees or flowers and such entities/objects may also be rendered based on certain features, selected from the entity/object models 1225 based on the analyzed semantics of the input 705. For example, for sky, there may be different renderings, some gloomy, some sunny, some cloudy, some raining, some snowing, etc. The selection of rendering parameters related to entity/object in the background may also be made based on the semantics of the input.

As discussed herein, the rendering of entities/objects in the scene may also need to be controlled based on various relations estimated from the semantics of the input. As shown in FIG. 8, characters Mike and Jenny may need to be rendered in a certain spatial manner to satisfy the semantics related to “Jenny is also watching Mike playing soccer.” For example, Jenny needs to be rendered facing Mike in order to be able to “watch” Mike's playing. In addition, as the input says that Mike is kicking a soccer ball, Mike and soccer ball may also need to be rendered in a certain way to reflect what is described.

To render the scene to satisfy the semantics, the semantics-based visual scene rendering unit 730 further comprises a spatial arrangement parameter determiner 1240, a functional part parameter determiner 1250, and an attribute alignment parameter determiner 1260. These three components take entities/objects to appear in the scene (determined by 1220) and their appearances (determined by 1230) as input and determine their poses, orientations, features, and coordinated alignment of features of different entities/objects. As discussed above, the direction of the sunlight in the sky needs to be rendered in a way that shine on entity Mike, as required by the input, one leg of Mike needs to be raised (to kick the ball) in a direction and to a degree that is aligned with the position of the soccer ball, and Jenny needs to be rendered facing Mike in a certain distance, etc. To determine such various parameters, the determiners 1240-1260 access the scene log information in 720 (as shown in FIG. 9B) on various relations (spatial, functional, and contextual) described in the input as well as entities/objects and generate rendering parameters/specifications with respect to each entity/object and send such rendering parameters/specifications to a visual scene rendering unit 1270. Some of the rendering parameters/specifications may be determined based on character motor feature models 1245. For example, if Mike is to be rendered to kick a soccer ball, the specification may be that the entity implementing Mike is to raise a leg with a certain angle and to a certain height and that height may be consistent with the height of the ball that he kicked. If additional information is known such as the user engaged in the dialogue is a lefty, then further specification may be that the leg raised is the left leg. When it is left leg, the position of the soccer ball to be rendered in the scene in relation to Mike may also needs to be accordingly adjusted. The correlations between required way to render an entity and parameters to be used to achieve the desired rendering may be provided in different model databases, such as a spatial relation rendering model storage 1280-1, a functional relation rendering model storage 1280-2, and an attribute alignment rendering model storage 1280-3, as shown in FIG. 12.

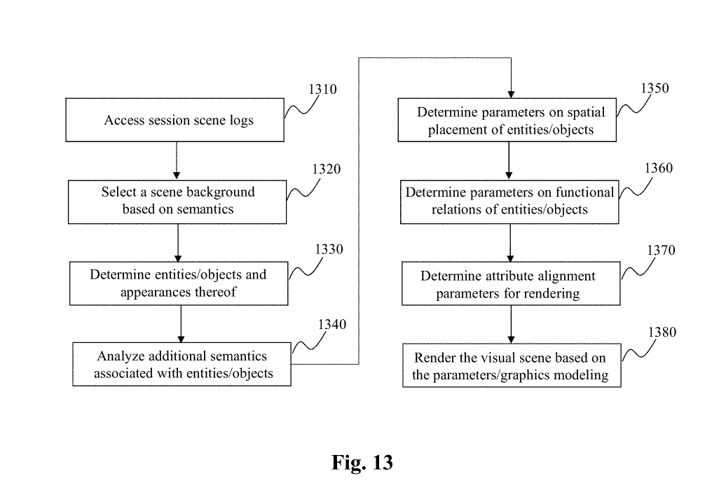

Once the specifications for the background of the scene and rendering parameters (from the semantic based background determiner 1210) and for each of the entities/objects (from 1230-1260) are provided to the visual scene rendering unit 1270, the rendering of the visual scene is carried out based on graphics rendering models 1275 in accordance with the specifications/features determined in accordance with the semantics of the input 705. FIG. 13 is a flowchart of an exemplary process of the semantics-based visual scene rendering unit 730, according to an embodiment of the present teaching. In operation, when triggered to render a visual scene, a relevant session scene log is accessed at 1310. Based on the relevant scene log, the semantic based background determiner 1210 selects, at 1320, a background for the scene based on semantics of the input. The entity/object determiner 1220 determines, at 1330, entities/objects that are to appear in the scene and the entity/object appearance determiner 1230 determines parameters associated with the appearances of the entities/objects to be rendered in the scene.

To determine the placement and visual characteristics of the entities/objects to be rendered in the scene, additional semantics related thereto are analyzed, at 1340, by the components 1240-1260. Based on an understanding of relevant semantics of the input 705, the spatial arrangement parameter determiner 1240 determines, at 1350, parameters related to spatial placement of the entities/objects to be rendered in the scene. Such parameters may specify not only location of each entity/object but also other corresponding parameters such as orientation (frontal face, side face, etc.), gesture (running or sitting), height, etc. of the entity/object. Similarly, the functional part parameter determiner 1250 determines, at 1360, any rendering parameters that are to be used to render different entities/objects to meet the semantic requirements, e.g., raising the left leg of one entity (Mike) to a certain height, pointing to a direction of another object (soccer ball) in the scene. Furthermore, the attribute alignment parameter determiner 1260 determines, at 1370, alignment of certain features of different entities to satisfy certain aspects of the semantics, e.g., rendering the upper right part of the sky (feature of one entity/object) brighter with a ray of light that will intersects the frontal face of another entity (Mike) who is standing on the ground.

With the selected background scene and entities/objects appearing in the background, the visual scene rendering unit 1270 then proceeds to render, at 1380, the visual scene in accordance with various determined rendering parameters based on, e.g., certain graphics rendering models 1275. As the background, entities/object, and associated rendering parameters are determined based on the analyzed semantics of the input 705, the visual scene so rendered is semantically consistent with the input 705, which may be provided in the speech form or in textual form. Based on the present teaching disclosed herein, a visual scene may be rendered based on dynamically provided input 705, which may be adaptively generated by an automated dialogue companion based on the dynamics of a conversation or by a user engaged in a human machine dialogue. The capability of generating and rendering a visual scene appropriate for the situation may improve user engagement and enhance user experiences.

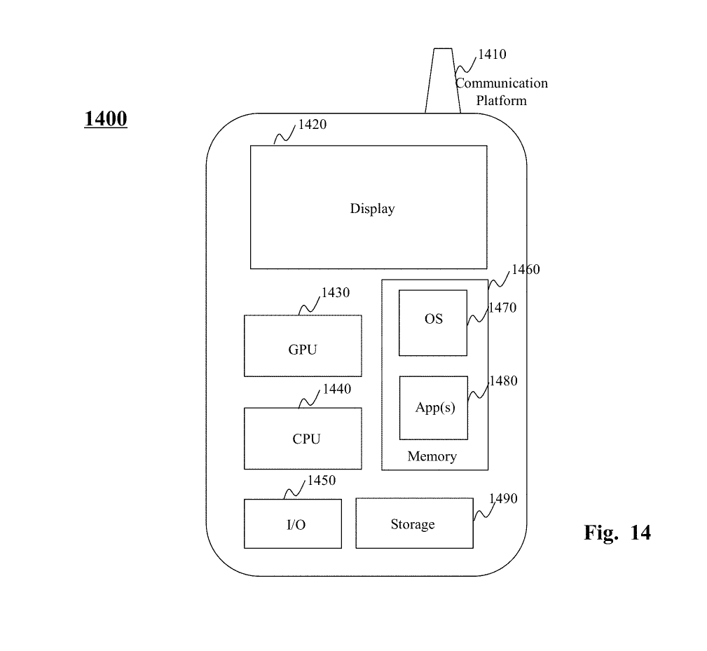

FIG. 14 is an illustrative diagram of an exemplary mobile device architecture that may be used to realize a specialized system implementing the present teaching in accordance with various embodiments. In this example, the user device on which the present teaching is implemented corresponds to a mobile device 1400, including, but is not limited to, a smart phone, a tablet, a music player, a handled gaming console, a global positioning system (GPS) receiver, and a wearable computing device (e.g., eyeglasses, wrist watch, etc.), or in any other form factor. Mobile device 1400 may include one or more central processing units (“CPUs”) 1440, one or more graphic processing units (“GPUs”) 1430, a display 1420, a memory 1460, a communication platform 1410, such as a wireless communication module, storage 1490, and one or more input/output (I/O) devices 1440. Any other suitable component, including but not limited to a system bus or a controller (not shown), may also be included in the mobile device 1400. As shown in FIG. 14 a mobile operating system 1470 (e.g., iOS, Android, Windows Phone, etc.), and one or more applications 1480 may be loaded into memory 1460 from storage 1490 in order to be executed by the CPU 1440. The applications 1480 may include a browser or any other suitable mobile apps for managing a conversation system on mobile device 1400. User interactions may be achieved via the I/O devices 1440 and provided to the automated dialogue companion via network(s) 120.

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

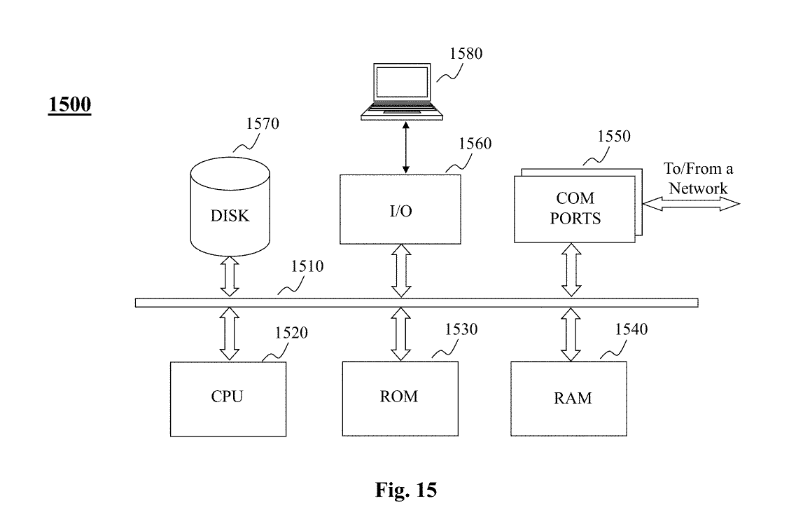

FIG. 15 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general purpose computer or a special purpose computer. Both can be used to implement a specialized system for the present teaching. This computer 1500 may be used to implement any component of conversation or dialogue management system, as described herein. For example, conversation management system may be implemented on a computer such as computer 1500, via its hardware, software program, firmware, or a combination thereof. Although only one such computer is shown, for convenience, the computer functions relating to the conversation management system as described herein may be implemented in a distributed fashion on a number of similar platforms, to distribute the processing load.

Computer 1500, for example, includes COM ports 1550 connected to and from a network connected thereto to facilitate data communications. Computer 1500 also includes a central processing unit (CPU) 1520, in the form of one or more processors, for executing program instructions. The exemplary computer platform includes an internal communication bus 1510, program storage and data storage of different forms (e.g., disk 1570, read only memory (ROM) 1530, or random access memory (RAM) 1540), for various data files to be processed and/or communicated by computer 1500, as well as possibly program instructions to be executed by CPU 1520. Computer 1300 also includes an I/O component 1560, supporting input/output flows between the computer and other components therein such as user interface elements 1580. Computer 1500 may also receive programming and data via network communications.

Hence, aspects of the methods of dialogue management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with conversation management. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the fraudulent network detection techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one machine including at least one processor, memory, and communication platform capable of connecting to a network for visualizing a scene, the method comprising:
receiving an input with a description of a visual scene;
performing linguistic processing of the input to obtain semantics of the input;
generating a scene log to be used for rendering the visual scene based on the semantics of the input, wherein
the scene log specifies at least one of
a background of the visual scene,
one or more entities/objects that are to appear in the visual scene, and
at least one parameter associated with the one or more entities/objects to be used to visualize the one or more entities/objects in the background in a manner consistent with the semantics of the input; and
rendering the visual scene based on the scene log by visualizing the background and the one or more entities/objects in accordance with the at least one parameter.

2. The method of claim 1, wherein the input is at least one of an utterance and a text.

3. The method of claim 2, wherein the step of performing linguistic processing of the input comprises:
recognizing a plurality of words in the input based on a vocabulary;
generating a language processing result based on the plurality of words in accordance with a language model; and
identifying the semantics of the input based on the language processing result.

4. The method of claim 1, wherein the at least one parameter includes at least one of a spatial parameter, a functional parameter, a contextual parameter, and a semantic parameter.

5. The method of claim 4, wherein the spatial parameter associated with an entity/object specifies at least one of a pose of the entity/object in the background, an orientation of the entity/object, and a spatial relatedness of the entity/object with respect to another entity/object.

6. The method of claim 4, wherein the functional parameter associated with an entity/object specifies a function of the entity/object determined based on the semantics of the input and an associated visual feature of another entity/object due to the function of the entity/object.

7. The method of claim 4, wherein the semantic parameter associated with an entity/object specifies a first visual feature associated with the entity/object and a second visual feature associated with a different entity/object, wherein the first and second features are in alignment based on the semantics.

8. Machine readable and non-transitory medium having information recorded thereon for visualizing a scene, wherein the information, when read by the machine, causes the machine to perform:
receiving an input with a description of a visual scene;
performing linguistic processing of the input to obtain semantics of the input;
generating a scene log to be used for rendering the visual scene based on the semantics of the input, wherein
the scene log specifies at least one of
a background of the visual scene,
one or more entities/objects that are to appear in the visual scene, and
at least one parameter associated with the one or more entities/objects to be used to visualize the one or more entities/objects in the background in a manner consistent with the semantics of the input; and
rendering the visual scene based on the scene log by visualizing the background and the one or more entities/objects in accordance with the at least one parameter.

9. The medium of claim 8, wherein the input is at least one of an utterance and a text.

10. The medium of claim 9, wherein the step of performing linguistic processing of the input comprises:
recognizing a plurality of words in the input based on a vocabulary;
generating a language processing result based on the plurality of words in accordance with a language model; and
identifying the semantics of the input based on the language processing result.

11. The medium of claim 8, wherein the at least one parameter includes at least one of a spatial parameter, a functional parameter, a contextual parameter, and a semantic parameter.

12. The medium of claim 11, wherein the spatial parameter associated with an entity/object specifies at least one of a pose of the entity/object in the background, an orientation of the entity/object, and a spatial relatedness of the entity/object with respect to another entity/object.

13. The medium of claim 11, wherein the functional parameter associated with an entity/object specifies a function of the entity/object determined based on the semantics of the input and an associated visual feature of another entity/object due to the function of the entity/object.

14. The medium of claim 4, wherein the semantic parameter associated with an entity/object specifies a first visual feature associated with the entity/object and a second visual feature associated with a different entity/object, wherein the first and second features are in alignment based on the semantics.

15. A system for visualizing a scene, comprising:
a textual input based scene understanding unit configured for
receiving an input with a description of a visual scene,
performing linguistic processing of the input to obtain semantics of the input, and
generating a scene log to be used for rendering the visual scene based on the semantics of the input, wherein
the scene log specifies at least one of
a background of the visual scene,
one or more entities/objects that are to appear in the visual scene, and
at least one parameter associated with the one or more entities/objects to be used to visualize the one or more entities/objects in the background in a manner consistent with the semantics of the input; and
a semantics based visual scene rendering unit configured for rendering the visual scene based on the scene log by visualizing the background and the one or more entities/objects in accordance with the at least one parameter.

16. The system of claim 15, wherein the input is at least one of an utterance and a text.

17. The system of claim 16, wherein the textual input based scene semantics understanding unit comprises:
a signal processing unit configured for recognizing a plurality of words in the input based on a vocabulary;
a language understanding unit configured for generating a language processing result based on the plurality of words in accordance with a language model; and
a semantic understanding unit configured for identifying the semantics of the input based on the language processing result.

18. The system of claim 1, wherein the at least one parameter includes at least one of a spatial parameter, a functional parameter, a contextual parameter, and a semantic parameter.

19. The system of claim 18, wherein the spatial parameter associated with an entity/object specifies at least one of a pose of the entity/object in the background, an orientation of the entity/object, and a spatial relatedness of the entity/object with respect to another entity/object.

20. The system of claim 18, wherein the functional parameter associated with an entity/object specifies a function of the entity/object determined based on the semantics of the input and an associated visual feature of another entity/object due to the function of the entity/object.

21. The system of claim 18, wherein the semantic parameter associated with an entity/object specifies a first visual feature associated with the entity/object and a second visual feature associated with a different entity/object, wherein the first and second features are in alignment based on the semantics.
